(19) United States
(12) Patent Application Publication
(10) Pub. No.: US 2016/0286519 A1
(43) Pub. Date: Sep. 29, 2016

(54) DETERMINING A LOCATION OF AN OFDM TRANSMITTER

(71) Applicant: Ramot at Tel-Aviv University LTD., Tel Aviv (IL)

(72) Inventors: Asaf Tzur, Tel Aviv (IL); Ofer Amrani, Tel Aviv (IL); Avishai Wool, Petah Tikva (IL)

(21) Appl. No.: 15/077,935

(22) Filed: Mar. 23, 2016

Related U.S. Application Data
(60) Provisional application No. 62/137,256, filed on Mar. 24, 2015.

(51) Int. Cl. H04W 64/00; G01S 5/02; H04B 7/06

(52) U.S. Cl. CPC H04W 64/00; H04B 7/0626; G01S 5/0284

(57) ABSTRACT

A method for estimating a location of an Orthogonal Frequency Division Multiplexing (OFDM) transmitter, the method may include receiving from an OFDM receiver or calculating channel state information (CSI) associated with OFDM packets received via multiple reception antennas; and processing the CSI associated with the OFDM packets to determine the location of the OFDM transmitter; wherein the determining of the location of the OFDM transmitter is further responsive to spatial relationships between the multiple reception antennas.

### CROSS REFERENCE TO RELATED APPLICATIONS

This application claims priority from U.S. provisional patent Ser. No. 62/137,256 filing date Mar. 24, 2015 which is incorporated herein by its entirety.

### BACKGROUND

In the following application a reference is made to the following documents:
{1} Hak5, “Wi-Fi pineapple mark v standard”, http://hakshop.myshopify.com/products/wifi-pineapple.
{2} R. Beyah, S. Kangude, G. Yu, B. Strickland, and J. Copeland, “Rogue access point detection using temporal traffic characteristics,” in Global Telecommunications Conference, 2004. GLOBECOM '04. IEEE, vol. 4, November 2004, pp. 2271-2275 Vol. 4.
{3} W. Wei, S. Jaiswal, J. Kurose, D. Towsley, K. Suh, and B. Wang, “Identifying 802.11 traffic from passive measurements using iterative bayesian inference,” IEEE/ACM Trans. Netw., vol. 20, no. 2, pp. 325-338, 2012.
{4} A. Venkataraman and R. Beyah, “Rogue access point detection using innate characteristics of the 802.11 mac.” in SecureComm, ser. Lecture Notes of the Institute for Computer Sciences, Social Informatics and Telecommunications Engineering, Y. Chen, T. Dimitriou, and J. Zhou, Eds., vol. 19. Springer, 2009, pp. 394-416.
{5} Motorola, “AirDefense,” http://www.airdefense.net.
{6} FLUKE, “AirMagnet,” http://www.flukenetworks.com/enterprisenetwork/wireless-design-analysis-and-security.
{7} A. Networks, “AirWave,” http://www.arubanetworks.com/products/airwave.
{8} Y. Sheng, K. Tan, G. Chen, D. Kotz, and A. Campbell, “Detecting 802.11 MAC layer spoofing using received signal strength,” in INFOCOM 2008. The 27th Conference on Computer Communications. IEEE, April 2008.
{9} V. Brik, S. Banerjee, M. Gruteser, and S. Oh, “Wireless device identification with radiometric signatures,” in Proceedings of the 14th ACM International Conference on Mobile Computing and Networking, ser. MobiCom '08, 2008, pp. 116-127.
{10} S. Jana and S. Kasera, “On fast and accurate detection of unauthorized wireless access points using clock skews,” Mobile Computing, IEEE Transactions on, vol. 9, no. 3, pp. 449-462, 2010.
{11} H. Han, B. Sheng, C. C. Tan, Q. Li, and S. Lu, “A measurement based rogue ap detection scheme.” in INFOCOM. IEEE, 2009, pp. 1593-1601.
{12} “A timing-based scheme for rogue AP detection,” IEEE Transactions on Parallel and Distributed Systems, vol. 22, no. 11, pp. 1912-1925, 2011.
{13} FLUKE, “AirCheck,” http://www.flukenetworks.com/enterprisenetwork/network-testing/AirCheck-Wi-Fi-Tester.
{14} P. Bahl and V. N. Padmanabhan, “RADAR: An in-building RF-based user location and tracking system,” in INFOCOM. IEEE, 2000, pp. 775-784.
{15} S. Sen, B. Radunovic, R. R. Choudhury, and T. Minka, “You are facing the mona lisa: Spot localization using PHY layer information,” in Proceedings of the 10th International Conference on Mobile Systems, Applications, and Services (MobiSys '12). New York, N.Y., USA: ACM, 2012, pp. 183-196.
{16} J. Xiao, K. Wu, Y. Yi, and L. M. Ni, “FIFS: Fine-grained indoor fingerprinting system,” in ICCCN. IEEE, 2012, pp. 1-7.
{17} H. Abdel-Nasser, R. Samir, I. Sabek, and M. Youssef, “MonoPHY: Mono-stream-based device-free wlan localization via physical layer information,” in WCNC. IEEE, 2013, pp. 4546-4551.
{18} Z. Yang, Z. Zhou, and Y. Liu, “From RSSI to CSI: Indoor localization via channel response,” ACM Comput. Surv., vol. 46, no. 2, pp. 25:1 25:32, December 2013.
{19} R. Henniges, “Current approaches of WiFi positioning,” in Service-centric Networking (SNET) Project (WT2011/2012). TU Berlin, 2012.
{20} A. M. Ladd, K. E. Bekris, A. Rudys, D. S. Wallach, and L. E. Kavraki, “On the feasibility of using wireless ethernet for indoor localization,” IEEE Transactions on Robotics, vol. 20, no. 3, pp. 555-559, 2004.
{21} M. Youssef and A. Agrawala, “The Horus WLAN location determination system,” in Proceedings of the 3rd International Conference on Mobile Systems, Applications, and Services (MobiSys '05). New York, N.Y., USA: ACM, 2005, pp. 205-218.
{22} H. Liu, Y. Gan, J. Yang, S. Sidhom, Y. Wang, Y. Chen, and F. Ye, “Push the limit of WiFi based localization for smartphones,” in Proceedings of the 18th Annual International Conference on Mobile Computing and Networking (Mobicom '12). New York, N.Y., USA: ACM, 2012, pp. 305-316.
{23} H. Lim, L.-C. Kung, J. C. Hou, and H. Luo, “Zero-configuration indoor localization over IEEE 802.11 wireless infrastructure,” Wireless Networks, vol. 16, no. 2, pp. 405-420, February 2010.
{24} K. Wu, J. Xiao, Y. Yi, M. Gao, and L. M. Ni, “FILA: Fine-grained indoor localization,” in INFOCOM, A. G. Greenberg and K. Sohraby, Eds. IEEE, 2012, pp. 2210-2218.
{25} K. Wu, J. Xiao, Y. Yi, D. Chen, X. Luo, and L. M. Ni, “CSI-based indoor localization,” IEEE Trans. Parallel Distrib. Syst., vol. 24, no. 7, pp. 1300-1309, 2013.
{26} J. Wang, Y. Chen, X. Fu, J. Wang, W. Yu, and N. Zhang, “3DLoc: Three dimensional wireless localization toolkit,” 2013 IEEE 33rd International Conference on Distributed Computing Systems, vol. 0, pp. 30-39, 2010.
{27} D. Niculescu and B. Nath, “VOR base stations for indoor 802.11 positioning,” in Proceedings of the 10th Annual International Conference on Mobile Computing and Networking (MobiCom '04). New York, N.Y., USA: ACM, 2004, pp. 58-69.
{28} S. Sen, R. R. Choudhury, and S. Nelakuditi, “SpinLoc: spin once to know your location,” in HotMobile, G. Borriello and R. K. Balan, Eds. ACM, 2012, p. 12.
{29} Z. Zhang, X. Zhou, W. Zhang, Y. Zhang, G. Wang, B. Y. Zhao, and H. Zheng, “I am the antenna: Accurate outdoor AP location using smartphones,” in Proceedings of the 17th Annual International Conference on Mobile Computing and Networking (MobiCom '11). New York, N.Y., USA: ACM, 2011, pp. 109-120.
{30} C. Wong, R. Klukas, and G. G. Messier, “Using WLAN infrastructure for angle-of-arrival indoor user location,” in VTC Fall. IEEE, 2008, pp. 1-5.
{31} J. Xiong and K. Jamieson, “Towards fine-grained radio-based indoor location,” in HotMobile, G. Borriello and R. K. Balan, Eds. ACM, 2012, p. 13.
{32} “SecureAngle: Improving wireless security using angle-of-arrival information,” in Proceedings of the 9th ACM SIGCOMM Workshop on Hot Topics in Networks (Hotnets-IX). New York, N.Y., USA: ACM, 2010, pp. 11:1-11:6.
{33} K. Joshi, S. Hong, and S. Katti, “PinPoint: Localizing interfering radios,” in 10th USENIX Symposium on Networked Systems Design and Implementation (NSDI 13). Lombard, Ill.: USENIX, 2013, pp. 241-253.
{34} D. Halperin, W. Hu, A. Sheth, and D. Wetherall, “Tool release: Gathering 802.11n traces with channel state information,” ACM SIGCOMM CCR, vol. 41, no. 1, p. 53, January 2011.
{35} J. J. van de Beek, O. Edfors, M. Sandell, S. K. Wilson, and P. O. Borjesson, “On channel estimation in OFDM systems,” in Proceedings IEEE VTC '96, November, 1996, pp. 815-819.
{36} “IEEE standard for information technology local and metropolitan area networks specific requirements—part 11: Wireless LAN medium access control (MAC) and physical layer (PHY) specifications amendment 5: Enhancements for higher throughput,” IEEE Std 802.11n-2009, 2009.
{37} D. Halperin, personal communication, 2014.

The referral to a document does not constitute an admittance that this is a prior art document.

Technological advances of recent years introduced a new threat to Wi-Fi networks: the appearance of rogue access points. With the growing trend of BYOD (Bring Your Own Device), it is now a simple matter for any smartphone with a cellular data plan to become an access point (AP). Moreover, an attacker can purchase a pre-built rogue AP, such as the Wi-Fi-Pineapple {1}, for about $100, and surreptitiously deploy it.

If such a rogue AP is placed within range, then mobile devices will automatically connect to it, and through it to the Internet, bypassing the officially-sanctioned AP. This makes several attacks feasible: the attacker can snoop all the traffic going through the rogue AP, and can apply man-in-the-middle attacks to break encrypted connections (and, e.g., steal passwords, read private email). Further, since a rogue AP has its own unrestricted data connection to the Internet, it bypasses all the corporate filters and data-leak-prevention (DLP) mechanisms.

Thus, unsuspecting users that connect to the rogue AP can have sensitive data, which should have been blocked by the DLP, stolen or leaked. Finally, a user connected to a rogue AP is not protected by any corporate firewall, or web filter, and is thus just as vulnerable to attack as a user connected to an open Wi-Fi hotspot outside the corporate network. For all the reasons above, eliminating rogue access points is a challenging security goal of growing importance.

To achieve this one should first detect that an AP is not a legitimate one. Many techniques for rogue AP detection have been presented recently. Detection of a rogue AP that uses a legitimate Ethernet connection can be performed by a network traffic analysis at the gateway {2}, {3}, {4}. Several commercial devices that search for rogue APs rely on various attributes of the AP, such as SSID, MAC address, and vendor name, comparing them to the known attributes of the legitimate APs {5}, {6}, {7}. Another approach is based on sniffing the wireless properties, e.g., RSS, frequency variations, and clock skew, and comparing them to the “fingerprints” collected earlier {8}, {9}, {10}. A recent work suggested measuring the communication parameters, e.g., the round trip time between the user and the DNS server, in order to independently determine whether an AP is a rogue AP {11}, {12}. There are also many variants and hybrid concepts for rogue AP detection.

Notably, even when the network administrators suspect that rogue APs have been positioned to attack the organization physically locating them is a difficult task. These are small, portable, battery-powered, devices. They can be easily hidden in a pocket, a drawer, or even on the wall of an adjoining office suite. The only reliable indication of their presence is their wireless footprint. Our goal in this work has been to design and prototype a Direction Finding device that can locate rogue access points, based on the characteristics of their radio transmission.

Available tools that can locate rogue APs, such as AirCheck {13}, rely on signal strength. Their use can be rather inconvenient: the operator needs to walk around, holding the locator, while checking where the signal strength seems to be maximal. Herein, our goal is to demonstrate that better location information can be extracted from the radio signal. Even without moving the locator device and with no cooperation from the transmitter or other devices, and by using an off the-shelf Wi-Fi receiver, it should be possible to identify the direction from which the signal is arriving. This should simplify the task of locating the rogue AP.

A related area of active research is that of indoor localization where a Wi-Fi device (laptop or smartphone) wishes to learn its own location. Recent works, e.g. {14}, {15}, {16}, {17}, indicate that such localization may be possible, with the assistance of the (legitimate) access points. While the problem of indoor localization has some similarities to ours, the main difference is that a rogue access point is non-cooperative, nor is it known in advance, thus many of the suggested solutions are inapplicable in our scenario.

We can identify three main trends in indoor localization of mobile Wi-Fi devices: (a) fingerprinting-based self-localization; (b) range-estimation; and (c) Angle-of-Arrival estimation. Some work is RSSI (Received Signal Strength Indicator)-based while the rest are CSI-based. Yang et. al. {18} offers a thorough overview of Wi-Fi localization technologies,

points the accessibility of CSI information using commercial hardware and presents a clear trend of using CSI-based systems rather than RSSI-based ones. Henniges {19} states that fingerprinting is the best-results technology, but points out the great effort required for training and calibrating these systems. This overview work claims that AoA localization is a good opportunity, although its greatest disadvantage is its employment of special hardware.

Fingerprinting-based self-localization: Several works suggested methods for fingerprinting-based self-localization employing the Wi-Fi infrastructure. The basic idea behind these methods is to hold an on-site training phase in which a specific “fingerprint” is collected for each geographic location.

The localization phase includes measurement of the channel properties (RSSI or CSI) and finding the best match to the fingerprints database. Naturally, all these methods require a preliminary on-site training campaign and are sensitive to environmental, and access-points deployment variations.

RSSI-based fingerprinting localization was suggested in the pioneering work of Bahl and Padmanabhan {14}. A similar approach was suggested in {20}. {21} works on the same concept and suggests probabilistic techniques to improve the localization accuracy. In addition to the disadvantages of other fingerprinting methods, these methods also suffer from the inherent instability of the RSSI parameter, which can vary dramatically due to physical changes in the channel.

Recently, novel methods of using CSI-based fingerprinting were suggested. {17} reports using a fingerprinting map that holds the magnitude of Wi-Fi CSI data. In {15} and {16} a fingerprints map of full CSI (complex value) is used, and the latter also tries to leverage the spatial diversity of MIMO.

Improved fingerprinting-matching by using a peer-assisting method was also suggested {22}.

Range estimation: Measuring the distance to a Wi-Fi device can be used as a part of trilateration-based localization system, or may alternatively be combined with a DF system for precise localization finding.

Several works investigated RSSI-based range estimation. In {14} and {21} interesting indoor RF propagation models are suggested. In {23}, the relationship between RSSI and range estimation is validated by an online calibration method using several access points. In {24} and {25} a novel method for CSI-based indoor range estimation is suggested.

Angle-of-Arrival estimation: Estimation of the AoA of a Wi-Fi device can be used as a part of triangulation-based localization system. It can also be combined with range estimation, or independently used for rogue AP localization.

Naive methods for RSSI-based AoA estimation, using dynamic directional antennas, were reported in {26} and {27}.

These methods require cumbersome hardware, and handle only one target at a time.

Recently, several methods that employ standard hardware—{28} and {29}—were reported. These methods require a physical user intervention for rotating the receiver device.

Static AoA estimation was also suggested. All of these methods employ special hardware for RF signal processing. {30} suggests using the Channel Impulse Response (CIR) measurements.

This method uses relatively cumbersome hardware, and requires a 4×4 MIMO channel. It was proved to work only at a very high SNR (60 dB)—these two characteristics are not very likely in current real-life Wi-Fi environments.

Xiong and Jamieson {31} (based on {32}) implement AoA estimation using phase measurements among several antennas.

By using special receiver hardware, they suggest RF signal processing techniques, and a variant of the MUSIC algorithm. The corresponding hardware involves 8 antennas as well as some RF sampling equipment, and hence it cannot be implemented using commercial off-the-shelf Wi-Fi products.

Yet another approach for AoA estimation is to measure the time-difference between receiving antennas {33}. This method also makes use of dedicated hardware. Its main contribution is an algorithm for identifying the line of sight (LOS) from multipath signals.

### SUMMARY

According to an embodiment of the invention there are provided systems, methods and computer readable media (non-transitory computer readable medium) for locating an OFDM transmitter based upon CSI. The location of the OFDM transmitter may be represented by a direction between the OFDM transmitter and the OFDM receiver. The location of the OFDM transmitter may be determine without moving the OFDM receiver although it may be determined even if the OFDM transmitter is moved and/or rotated about its axis.

According to an embodiment of the invention there may be provided a method for estimating a location of an Orthogonal Frequency Division Multiplexing (OFDM) transmitter, the method comprising: receiving from an OFDM receiver or calculating channel state information (CSI) associated with OFDM packets received via multiple reception antennas when the OFDM receiver is positioned at a first location and at a first orientation; and processing the CSI associated with the OFDM packets to determine the location of the OFDM transmitter; and wherein the determining of the location of the OFDM transmitter is further responsive to spatial relationships between the multiple reception antennas.

According to an embodiment of the invention there are provided a non-transitory computer readable medium that stores instructions that once executed by a computer cause the computer to perform the steps of: receiving from a Orthogonal Frequency Division Multiplexing (OFDM) receiver or calculating channel state information (CSI) associated with OFDM packets received via multiple reception antennas when the OFDM receiver may be positioned at a first location and at a first orientation; and processing the CSI associated with the OFDM packets to determine the location of the OFDM transmitter; wherein the determining of the location of the OFDM transmitter may be further responsive to spatial relationships between the multiple reception antennas.

The estimating of the location of the OFDM transmitter may be executed without moving the multiple reception antennas.

The processing may include distinguishing between CSI of OFDM packets related to different subcarriers.

The processing may include estimating channel responses related to different subcarriers.

The processing may include ignoring CSI related to subcarriers of the OFDM packets that propagate through channels that exhibit a span of channel responses that exceed a predefined threshold.

The processing may include compensating for an angular bias of the OFDM receiver.

The processing may include resolving at least one ambiguity out of a phase periodic ambiguity and a symmetric ambiguity; wherein the resolving of the phase periodic ambiguity may include selecting between multiple estimated phase differences, wherein each estimated phase difference may be indicative of a differences in timing of receptions, by the multiple reception antennas, of same OFDM packets; wherein the multiple estimated phase differences differ from each other multiple integers of one hundred and eighty degrees; and wherein the resolving of the symmetric ambiguity may include selecting between a first estimated value of an angle of arrival of an OFDM packet and between a second estimated value of the angle of arrival of the OFDM packet, wherein a sum of the first estimated value and the second estimated value equals one hundred and eighty degrees.

The resolving of the at least one ambiguity may include: receiving from the OFDM receiver or calculating CSI associated with another set of OFDM packets received via multiple reception antennas when the multiple reception antennas were at the first position but may be oriented at a second orientation; and processing the CSI associated with the additional set of OFDM packets.

The processing may include comparing between intensities of same OFDM packets that were received by different reception antennas.

The CSI may include phase information that is inconsistent between OFDM packets, wherein the processing may include compensating for the inconsistency.

The phase information of one OFDM packet may be calculated regardless of phase information of another OFDM packet.

The compensating may be responsive to a distribution of phase differences, wherein each phase difference may be indicative of an estimated phase difference between receptions of a same OFDM packet by different reception antennas.

The compensating may include finding a most popular phase difference value within a predefined angular range and adding a phase offset to the most popular phase difference to provide an estimate of the phase difference.

The method may include calculating the location of the OFDM transmitter in response to phase differences calculated for multiple antennas and for one or multiple OFDM packets per one or many subcarriers.

The processing may include clustering subcarriers of the OFDM packets to clusters according to channel responses associated with the subcarriers and providing an estimate of a location of the transmitter per cluster.

The estimating of the location of the OFDM transmitter may be executed while moving the multiple reception antennas.

The method may include providing an indication about the estimated location of OFDM transmitter.

The indication may be a visual indication.

The visual indication may be an arrow that points towards the estimated location of the OFDM transmitter.

The indication may be an audio indication.

According to an embodiment of the invention there are provided a computerized device that may include a memory unit and a processor, wherein the memory unit may be configured to store channel state information (CSI) associated with Orthogonal Frequency Division Multiplexing OFDM packets received via multiple reception antennas; wherein the processor may be configured to process the CSI associated with the OFDM packets to determine the location of the OFDM transmitter; wherein the determining of the location of the OFDM transmitter may be further responsive to spatial relationships between the multiple reception antennas.

The multiple reception antennas may belong to the device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a receiver that includes two receive antennas, a wavefront, and a complex representation of signals received by the two receive antennas;

FIG. 2 illustrates an OFDM receiver and transmitter;

FIG. 3 illustrates various ambiguities;

FIG. 4 illustrates a lab experimental setup according to an embodiment of the invention;

FIG. 5 illustrates experimental results according to an embodiment of the invention;

FIG. 6 illustrates experimental results according to an embodiment of the invention;

FIG. 7 illustrates a field experimental setup according to an embodiment of the invention;

FIG. 8 illustrates experimental results according to an embodiment of the invention;

FIG. 9 illustrates experimental results according to an embodiment of the invention;

FIG. 10 is a flow chart of a method according to an embodiment of the invention;

FIG. 11 illustrates experimental results according to an embodiment of the invention;

FIG. 12 illustrates experimental results according to an embodiment of the invention;

FIG. 13 is a flow chart of a method according to an embodiment of the invention;

FIG. 14 illustrates a system according to an embodiment of the invention; and

FIG. 15 is a flow chart of a method according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There is provided a method of using multiple receiving antennas and OFDM Channel State Information (CSI) as the basis for implementing interferometry Direction Finding (DF) by means of standard off-the-shelf receiver with only two antennas. It is noted that the method can be applied when using two or more antennas—including two or more reception antennas and/or two or more transmission antennas and the like.

The method may also address ambiguities, multipath effects and noisy measurements by properly manipulating the available CSI measurements.

The term “hat” represents the following mathematical symbol Λ—thus H that means Ĥ

The inventors used a prototype device using the Intel 5300 Wi-Fi as a platform. This platform was chosen since it has drivers and firmware that make the CSI data available {34}. The prototype uses only 2 receiving antennas. The inventors evaluated the prototype's performance both in a laboratory setting, using a noise-free RF Channel simulator, as well as in a realistic field test, with several Wi-Fi transmitters, multipath effects and other sources of interference. The prototype was able to calculate the AoA with a median error of 8-15 Degrees.

Since the proposed method utilizes inherent characteristics of MIMO and OFDM, it is also readily applicable for other relevant wireless systems such as LTE.

Interferometry-Based Direction Finding An important ingredient for calculating the AoA of a wireless signal is its phase. This quantity changes linearly from zero to 2 Pi every carrier-signal wavelength Lambda, along the path from the transmitter to the receiver. This means that the received signal has accumulated phase Phi determined by the path length L=2 Pi*L/Lamdba.

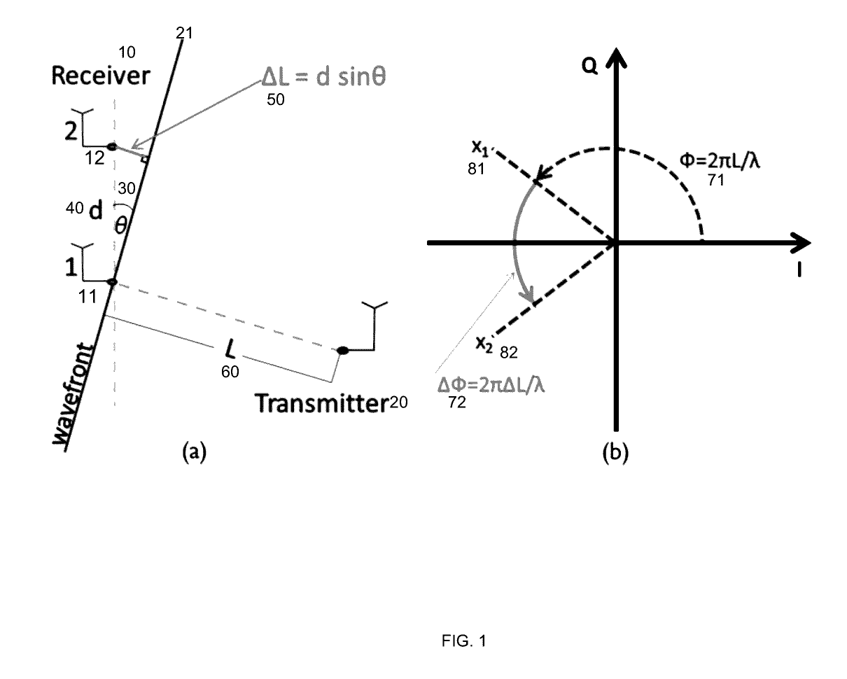

FIG. 1 part (a) illustrates a transmitter 20 located at a distance L 60 from the wavefront 21 when the wavefront reaches first receive antenna 11 of receiver 10, the second antenna 12 of the receiver 10 is located at a distance d 40 from the first antenna.

There is an angle Theta 30 between the wavefront 21 and the plane in which the first and second receive antennas are positioned. When the wavefront 21 reaches the first receive antenna 11 it is at a distance of DeltaL 50 (physical path difference) from the second receive antenna 12.

DeltaL=d*sinusTheta.

FIG. 1 part (a) illustrates a signal reaching the receiver at bearing angle Theta, arriving at the two antennas (x1 and x2) with a total path-length difference of DeltaL. FIG. 1 part (b) illustrates the complex representation of the received signals at both antennas—the signal received at the first receive antenna 11 is denoted x1 81 and the signal received at the second receive antenna 12 is denoted x2 82. The phase difference between the two antennas is denoted DeltaPhi and equals 2*Pi*DeltaL/Lambda.

The phase is particularly easy to visualize by an In-phase/Quadrature (IQ) plot, as depicted in FIG. 1 part (b). The accumulated phase Phi is portrayed in FIG. 1 part (b) by the angle measured from the (positive) I axis to the cross labeled x1 81. When the receiver has two antennas located at a certain distance d apart from each other, FIG. 1 part (a), the physical path of the signal arriving at bearing angle (AoA) Theta is greater to the second antenna than it is to the first.

The difference in the physical paths of the received signals deltaL causes a difference in the phase of the received signals DeltaPhi=Phi2−Phi1, according to:

DeltaPhi=2Pi*DeltaL/Lambda (2)

Consequently, obtaining Phi with a two-antenna receiver, in the absence of multipath, is simple. First, measure the phase of the signal received at each of the two antennas (Phi1 and Phi2), and then, according to DeltaPhi solve for Theta using:

Theta=arcsin(DeltaPhi*Lambda/2Pi*d)

Luckily, accurate phase measurements are regularly collected in modern wireless devices for various signal detection purposes. the inventors show in the sequel how two basic technologies commonly used in modern wireless standards—MIMO and OFDM—allow us to compute DeltaPhi by employing off-the-shelf Wi-Fi boards.

B. Multiple-Input Multiple-Output (MIMO) One of the characteristics of modern wireless standards, e.g., IEEE802.11n and LTE, is the employment of Multiple-Input Multiple-Output (MIMO). In this physical layer (PHY) configuration the radio device uses more than one antenna for transmitting and receiving. MIMO is used to improve the system's performance via spatial diversity, rather than to support interferometry; there are several communication techniques that take advantage of spatial diversity for achieving higher throughput.

Nonetheless, for our needs, the inventors note that standard off-the-shelf hardware of modern wireless devices typically consists of at least two antennas at the receiver side, and supports separate processing for each antenna.

C. Orthogonal Frequency Division Multiplexing (OFDM) Another basic characteristic of modern wireless standards is the usage of Orthogonal Frequency Division Multiplexing (OFDM) as a bandwidth-efficient technology for supporting high data rates.

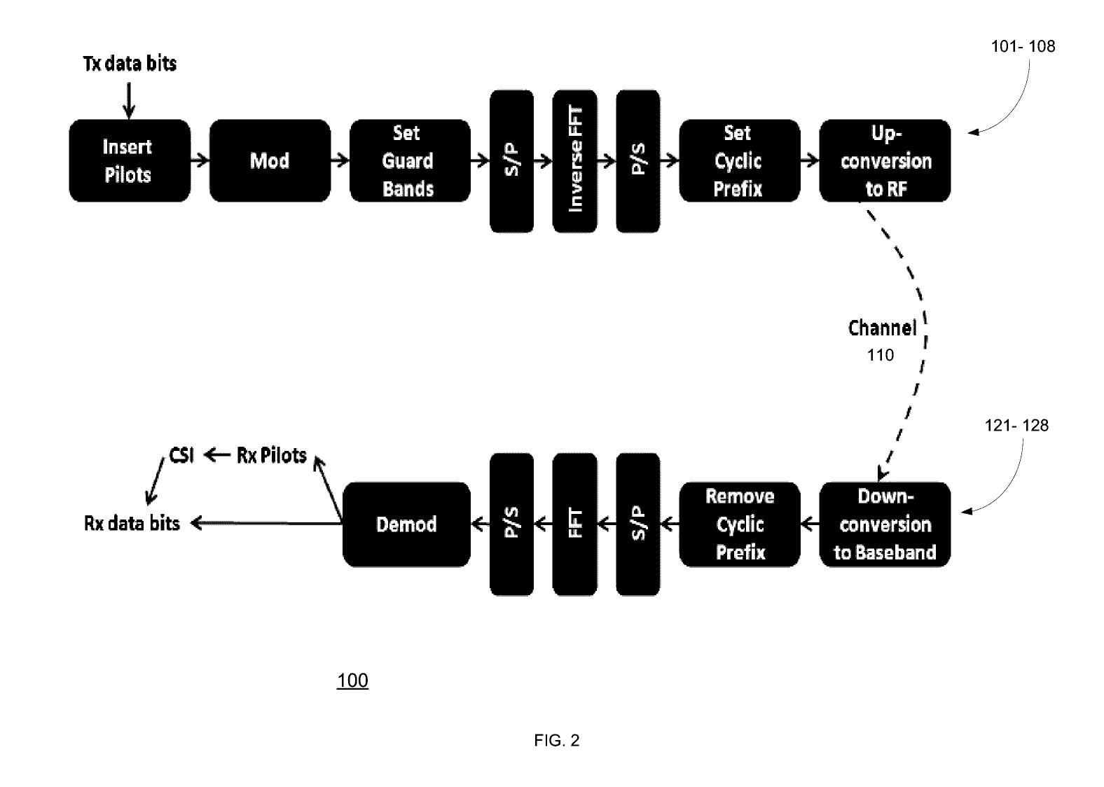

At the OFDM transmitter, the incoming data stream is split into multiple narrow and orthogonally overlapped subcarriers. The data on each subcarrier is then modulated, i.e. converted, to the time domain by using inverse Fast Fourier Transform (IFFT). The time-domain signal is then up-converted to radio frequency and transmitted through the channel; see top segment of FIG. 2 that illustrates an OFDM framework. At the transmitter (blocks 201-208) the transmitted data bits are processed by pilot insertion, modulation, setting guard bands, serial to parallel conversion, inverse FFT operation, parallel to serial conversion, setting cyclic prefix and up conversion to RF before transmitted over channel 110. At the receiver (boxes 121-128) the received signals are down-converted to baseband, cyclic prefix is removed, serial to parallel conversion, FFT transformed, parallel to serial conversion, demodulated and outputted, wherein in addition the pilots are removed and CSI is calculated.

At the receiver, after frequency down conversion, the signal is converted back to the frequency domain via FFT. The recovered samples are then demodulated and the transmitted data bits are detected.

Orthogonality, viewed in the frequency domain, is achieved in OFDM by choosing the symbol length and the frequency separation between the subcarriers such that the peak of each subcarrier falls on the nulls of the others. The IEEE802.11n (High-Throughput, 20 MHz band) uses 64 subcarriers (pilots and guard-bands included) with spacing of 312.5 kHz, and IDFT/DFT period of 3.2 microSeconds.

D. Channel State Information (CSI) For its proper operation, OFDM technology requires the calculation of Channel State Information (CSI) for each subcarrier. The CSI holds the channel properties of the communication link. More specifically, CSI describes what the transmitted signal has undergone while passing through the channel and reveals the combined effect due to scattering, fading, and power decay. An OFDM system viewed in the frequency domain can be modeled by

y=Hx+n; (4)

Where y and x are the received and transmitted vectors respectively, H is the channel matrix and n is an additive white Gaussian noise (AWGN) vector.

To successfully detect the message x from the received signal y, distorted by fading and noise, OFDM receivers first need to estimate the channel. This is achieved by transmitting predetermined symbols a.k.a. preamble, or pilots. Thus, the CSI, given for all subchannels in the form of the matrix (H hat), can be estimated according to Equation (4).

There are many techniques that provide precise CSI estimation based on maximum-likelihood (ML) or minimum mean square error (MMSE) criteria {35}. Since OFDM reception requires accurate estimation of the CSI, it is safe to assume that this information is also available for other uses—and in particular for AoA derivation.

### III. SYSTEM DESIGN

In this section there is provided the proposed system architecture, discuss ambiguity issues and suggest three methods that promote ambiguity resolution.

System Architecture

As previously discussed, OFDM systems require accurate CSI knowledge for their proper operation. Note that CSI is given in the form of a complex-valued matrix for each antenna pair (Tx antenna−Rx antenna). If available, the CSI can be used for obtaining DeltaPhi=Phi2−Phi1, and consequently Theta in accordance with Equation (3).

Since the inventors implement this method while using a single pair of co-planer, parallel, receive antennas, the measured AoA is actually the projected angle on the plane of the receiving antennas: Assuming the antennas are placed vertically, we can measure the horizontal projection of the AoA.

Ambiguity Issues

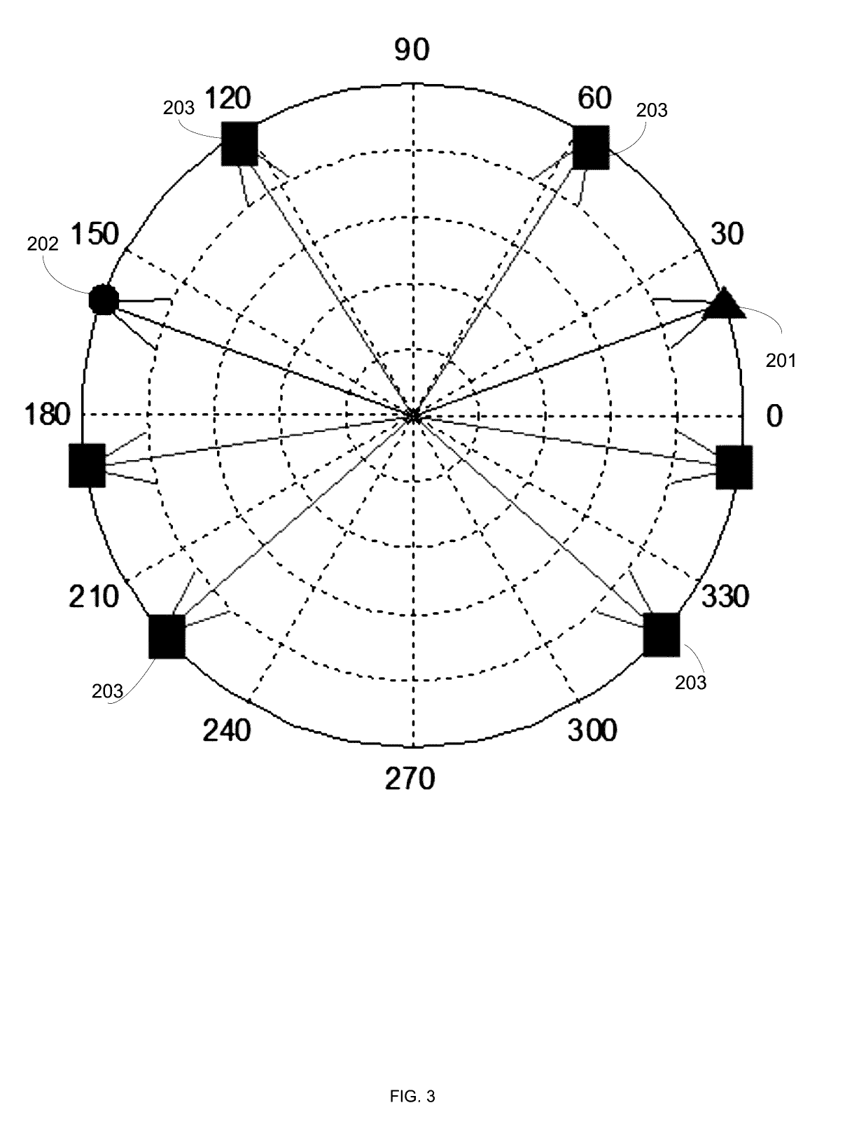

FIG. 3 illustrates Angle-of-Arrival ambiguity when Physical AoA 201 (triangle)=20 Degrees and d=2*Lambda (assuming the receiving antennas are located at orientations 90 Degrees and 270 Degrees).

Symmetric Ambiguity is represented by dot 202 and Phase-Periodic Ambiguity is represented by squares 203.

When using a single pair of receive antennas for interferometry DF system, two ambiguity issues arise:

1) Symmetric Ambiguity: Since the interferometry system calculates Theta by measuring DaltaL as shown in FIG. 1 part (a), it is clear that the system cannot distinguish between the physical AoA Theta and its symmetric reflection at Pi-Theta. This ambiguity is referred here as Symmetric Ambiguity. His reflection is showed in the example presented in FIG. 3 as a black-dot.
2) Phase-Periodic Ambiguity: Another ambiguity is caused by the periodicity of the phase. As previously described, the CSI phase measurement provides the phase accumulated along

The path from the transmitter to the receiving antenna. Hence, when a measured phase difference between two receiving antennas DeltaPhiHat=Phi2Hat−Phi1Hat is measured in the range {−Pi;Pi}, the physical phase difference is: DeltaPhi=DeltaPhiHat+2 Pi*k (5) for some integer k.

Note that according to Equation (3), the absolute value of DeltaPhi does not exceed 2 Pi*d/Lambda (6)

In many cases, for a given measured phase difference DeltaPhi hat there is more than one solution DeltaPhi to Equations (5) and (6). This ambiguity in the phase difference DeltaPhi naturally causes ambiguity in the calculated AoA Theta. Since this ambiguity is caused by the periodicity of the phase, it is referred here as Phase-Periodic Ambiguity.

To better understand the nature of this ambiguity, there is provided a short example (shown in FIG. 3 as red-squares), in which d=2λ and the physical AoA is θ=20 Degrees (shown in FIG. 3 as blue-triangle). According to Equations (1) and (2) the physical phase difference

$$Δ φ = 2 π \frac{d}{λ} sin θ \approx 1.4 π .$$

When the measured phase difference is in the range {−Pi; Pi}, we get a measured phase difference Δ\hat{φ}=−0.6π. According to Equations (5) and (6), possible solutions are Δ\hat{φ}=−2.6 Pi; −0.6 Pi; 1.4 Pi; 3.4 Pi. Thus, according to Equation (3), possible AoA solutions are Theta=−41 Degrees; −9 Degrees; 20 Degrees; 57 Degrees.

The phase-periodic ambiguity is also coupled with the symmetric ambiguity, causing phase-periodic reflections of the symmetric reflection. In the above example, the symmetric reflection is θ̅=160 Degrees and its coupled reflections are θ=−139 Degrees; 171 Degrees; 160 Degrees; 123 Degrees.

If the physical distance between the receiving antennas d is small enough that

$$d < \frac{λ}{2} ,$$

then phase-periodic ambiguity is prevented (k=0). However, since it is desired to use standard off the-shelf hardware without restricting the geometrical structure of the receiver, it is suggested three methods for solving the ambiguity which arises when the distance between the receiving antennas is

$$d \geq \frac{λ}{2}$$

Ambiguity Resolution

Many other works suggest solving the ambiguity issues by using more than two antennas at the receiver's side, e.g., {32} suggests using as many as 8 antennas. It is suggested here three methods for solving ambiguity, using a standard off-the-shelf receiver with only a single pair of antennas.

Mechanical Intervention: The basic idea is that when the receiver is rotated by some known angle α, the measured AoA of the physical wavefront will also be rotated exactly by α. Due to the non-linear dependence of Δφ on the bearing angle, as in Equation (3), the other reflections will be rotated by angles different from α.

Let us denote the original physical AoA as θ₀, the respective physical phase difference as Δφ₀, and the measured phase difference Δ\hat{φ}₀. The Symmetric Reflection is θ̅₀̅=1800−θ₀, and the Phase-Periodic Reflections are noted as θ^{pp}_{0,k}=θ^{pp}_{0,1}, θ^{pp}_{0,2}, . . . (Δ\hat{φ}^{pp}_{0,k} are solutions of Equations (5) and (6) for a given Δ\hat{φ}₀ and θ^{pp}_{0,i} are the respective AoAs according to Equation (3)).

After rotating the receiver by angle α, the physical AoA will also be rotated by the same angle and be θ₁=θ₀+α, and the phase difference will be changed respectively to Δφ₁.

The symmetric reflection will rotate to the other direction and be θ̅₁̅=180°−θ₀−α, thus it can be identified.

The phase-periodic reflections will change according to Equations (5) and (6) for the new Δ\hat{φ}₁. Since the AoA θ is proportional to arcsin(Δφ) (a non-linear dependence of Δφ), as in Equation (3), the new phase-periodic reflections θ^{p}ₚ_{_{1,k}} will be proportional to arcsin (Δ\hat{φ}₁+2π·k) Thus, when rotating the receiver by α, for each k, θ^{p}ₚ_{_{1,k}} will be rotated by different angle—different from α.

Thus by generating a known rotation a of the receiver, the physical AoA and its ambiguous reflections may be distinguished from each other. This method is relevant for solving both types of ambiguities.

Frequency Diversity: The basic idea is to employ the frequency diversity of the OFDM technology. Since the phase-periodic reflections arise in different angles that are wavelength dependent, for each subcarrier (frequency) the reflections arise in different geometric angles, while only the physical AoA would be the same for all subcarriers (frequencies).

This method does not require any mechanical intervention, and is based only on improved signal processing, when using the frequency diversity characteristic of OFDM. As previously described, OFDM makes use of a wide bandwidth by dividing it into orthogonal narrow subcarriers. As the CSI provides the phase measurement of each antenna for each subcarrier, the phase difference between two antennas Δ\hat{φ}_{f} for each subcarrier f can be measured separately, and get

Δφ_{f}=Δ\hat{φ}_{f}+2π·k_{f} (7)

Where Δφ_{f} and Δ\hat{φ}_{f} are, respectively, the physical and measured phase difference between the antennas for subcarrier f, and k_{f} is the ambiguity integer for subcarrier f. From Equation (2), it is easy to see that for all subcarriers f and g:

Δφ_{f}·λ_{f}=Δφ_{g}·λ_{g} (8)

When λ_{f} and λ_{g} are the wavelengths of subcarriers f and g respectively. Thus,

$${k}_{f} = \frac{Δ {\hat{φ}}_{ℊ} {λ}_{ℊ} - Δ {\hat{φ}}_{f} {λ}_{f}}{2 π {λ}_{f}} + \frac{{λ}_{ℊ}}{{λ}_{f}} {k}_{ℊ} \qquad ( 9 )$$

Where Δ\hat{φ}_{f}, Δ\hat{φ}_{g} are the measured phase differences of subcarriers f,g respectively.

Since both k_{f} and k_{g} must be integers and

$$\vert θ \vert < \frac{π}{2} ,$$

a unique solution (k_{f}; k_{g}) can be found, and the Phase-Periodic ambiguity is solved.

Note that this resolution method requires a precise measurement of the phase difference. In practice, the measurement of Δ\hat{φ}_{f} and Δ\hat{φ}_{g} is not perfectly accurate. Thus it might be impossible to find ambiguity integers (k_{f} and k_{g}) that solve Equation (9). A naive practical implementation of this ambiguity resolution method may be to choose ambiguity integers k_{f} and k_{g} which minimize the value of |Δφ_{f}λ_{f}−Δφ_{g}λ_{g}|.

Let us note the maximal absolute error of the phase difference measurement as E. Thus the worst case is when the maximal error is added to one phase difference measurements (e.g., Δφ_{f}) and subtracted from the second phase difference measurement (e.g., Δφₖ). A correct resolution of the ambiguity will be achieved when |(Δφ_{f}+ε)λ_{f}−(Δφ_{g}−ε)λ_{g}| is smaller than the value of its two adjacent phase-periodic reflections. I.e., in order to resolve the ambiguity correctly, a should be limited according to the following inequality:

|(Δφ_{f}+ε)λ_{f}−(Δφ_{g}−ε)λ_{g}|<|(Δφ_{f}+ε±2π)λ_{f}−(Δφ_{g}−ε±2π)λ_{g}| (10)

Using Equation (8), we get:

$$\vert ɛ \vert < π \cdot \frac{\vert {λ}_{f} - {λ}_{ℊ} \vert}{{λ}_{f} + {λ}_{ℊ}} \qquad ( 11 )$$

In order to obtain a correct ambiguity resolution with the highest possible error, the first and last subcarrier (for maximizing |λ_{f}−λ_{g}|), of the first channel may be chosen (for minimizing λ_{f}+λ_{g}). In this case, plugging the best Wi-Fi (HT CBW 20) parameters {36} into Equation (11): λ_{f}=12.483 cm, λ_{g}=12.393 cm, finds that the largest phase difference measurement error c that would still allow a correct resolution of the Phase-Periodic ambiguity using this method is

$$ɛ \text{<≈} \frac{π}{275} .$$

Amplitude Information: When the wavefront arrives at the receiver at a bearing angle θ≠0, one of the two antennas—the front antenna—receives the signal before the second antenna—the rear antenna. Our preliminary findings indicate that the received signal at the rear antenna, is attenuated in comparison to the signal received at the front antenna, probably due to the presence of the front antenna. The difference in the amplitude of the signals that arrive at each of the two antennas, seems to depend on the bearing angle θ—the bigger θ is, the greater the amplitude difference.

As the Received Signal Strength Indication (RSSI) information is usually too rough for measuring fractions of dBm, it is suggested using the absolute value of the CSI of each antenna for this goal. Note, though, that this method also does not help to solve the Symmetric Ambiguity.

Performance Limits

In the previous subsections, it was assumed that one coherent wavefront transmitted by a single transmitter arrives at the receiver. In real-life situations, there are two major issues affecting interferometry DF methods: (a) many wireless devices share the same bandwidth at the same time and space, and (b) the environment usually contains reflectors and noisy channels that cause the arrival of the received signal from several directions and thus a non-coherent wavefront, usually called multipath. Here we discuss the effect of these two issues and suggest a method for filtering out noisy data.

Receiving Signals from Multiple Transmitters: In order to measure the AoA of a single transmitter, the transmitted signal should be received at the receiver without an addition of other signals transmitted from other transmitters. Whether working in OFDMA (Orthogonal Frequency Division Multiple Access) or “simple” TDMA (Time Division Multiple Access), modern wireless standards support sharing of time and frequency domains between several transceivers, which communicate in parallel. Thus, each received packet contains the signal of a single transmitter, which can be identified. In the IEEE802.11 standard, for example, a time sharing mechanism is used by implementing the Carrier Sense Multiple Access with Collision Avoidance (CSMA/CA) method. According to this method, for a device to transmit, it must first sense the medium to determine if another device is transmitting. Only if the medium is not determined to be busy, the transmission may proceed {36}.

Thus a standard receiver is able to process and decode the signal from a single transmitter during each frame slot—and our DF technique relies on this inherent behavior.

Multipath and Other Channel Effects: In real environments multipath effects are quite common, thus the multiple paths' signals accumulate in the I-Q plot (recall FIG. 1(b)), breaking the simple exposition presented earlier. However, in many cases we can assume that the Line-of-Sight (LoS) signal is much stronger than the multipath reflections, thus it is dominant and can be recognized on the I-Q plot, and the above described technique is applicable for DF. In other scenarios even when there is no strong LoS signal, there is often one strong reflected signal, and the technique works as well, finding the AoA of the dominant signal. In scenarios in which there is more than one dominant coherent wavefront, the system may measure the AoA of each of the wavefronts. Scenarios in which there is no dominant coherent signal, and the receiver receives non-coherent wavefront of several reflectors, are beyond the performance limits of the interferometry DF method.

Note that non-coherent multipath scenarios are characterized by a frequency-selective channel response, while coherent wavefront scenarios are characterized by a flat-channel. The CSI data, which can be used for our processing, provides us with information about the channel state. It is suggested using the CSI magnitude of each subcarrier in order to understand the nature of the channel, and thus the applicability of our technique.

### IV. NUMERICAL EXPERIMENTS

In order to explore the feasibility of our approach the inventors first developed a MATLAB digital simulation of a Wi-Fi IEEE802.11n MIMO-OFDM signal and carried out a series of numerical experiments.

Simulation Design

The simulation includes the following components: 1) Generating a baseband OFDM signal the inventors first generated the baseband signal of OFDM, as shown on FIG. 2, which included known pilot symbols, with the parameters of IEEE802.11n, according to Table 20-5—Timing-related constants of {36}. The inventors generated the baseband signal at a sampling-rate of 20 MHz (symbol length of 50 ns), with random QPSK data bits. The pilot symbols were

$$\frac{( i + j )}{\sqrt{2}} .$$

Up-converting to transmitted RF signal: the inventors produced the transmitted RF signal, by over-sampling the baseband OFDM signal at a rate of 100 GHz (symbol length was 10 ps),

And mixing this over-sampled baseband OFDM signal with the carrier signal: Signal_{car}=cos(2πf_{car}·t)+j·sin(2πf_{car}·t), for f_{car}=2.437 GHz. This signal represents the transmitted

RF signal of an OFDM communication device using single transmitting antenna.

Adding synchronization error delay: Since the receiver and the transmitter are synchronized, the only part of the propagation delay that the inventors model is the synchronization error. This error delay was implemented by dropping the first n_{nsync}_{_}_{delay} elements of the transmitted RF signal, which means dropping the first (n_{nsync}_{_}_{delay}·10)ps (ps=10⁻¹² sec) of the signal (n_{nsync}_{_}_{delay} is a simulation parameter, and the simulation sampling rate was set to 100 GHz).

Adding geometric delay to a second antenna: the inventors modeled the two receiving antennas, receiving the same RF signal with a time difference according to the geometric setup.

The first (front) antenna's received RF signal is the previously described signal (which includes only the synchronization delay), and the second (rear) antenna's received RF signal is delayed by additional ((n_{geometric}_{_}_{delay}·10)ps, for simulation parameter n_{geometric}_{_}_{delay}.

Implementing the OFDM receiver and finding the CSI: the inventors down-converted the signal back to baseband, and then implemented the OFDM receiver, as shown in FIG. 2, to obtain the received pilot symbols. According to Equation (4), the inventors found the CSI (Ĥ). The inventors used the angle of the CSI data as the absolute phase of the received signal. The inventors repeated this procedure for each of the received signals (for two receiving antennas), and obtained \hat{φ}₁ and \hat{φ}₂ from which the inventors calculated Δ\hat{φ}.

B. Results

Running this simulation with randomly generated values of n_{nsync}_{_}_{delay} and a series of values of n_{geometric}_{_}_{delay}, the inventors succeeded to get Δ\hat{φ}=2πf_{car}·(n_{geometric}_{_}_{delay}·10 ps), as expected according to theory:

Δ\hat{φ}=2πf_{car}·Δt (12)

Where f_{car} is the carrier frequency, and At is the delay between the two receiving antennas.

### V. LABORATORY EXPERIMENTS

The next step in our work was to implement a prototype of our approach using hardware equipment, and evaluate its performance in a controlled lab environment.

Prototype Design

Our prototype is for an IEEE802.11n system and relies on the Intel 5300 Wi-Fi hardware platform. This module supports up to 3 antennas. The main advantage of this platform is that there are publicly-available firmware and drivers that export CSI data. Specifically, the Wi-Fi card firmware and drivers developed and published in {34} export CSI data for 30 subcarriers, for each antenna, and for each received packet. Hereinafter, by “packet” we refer to a legitimate Wi-Fi packet.

We connected the module to a desktop computer using a PCIeMini-to-PCIe adapter that is attached to the antennas. On this adapter the three antennas are positioned at a distance of 14 mm apart, so the distance between the left- and the rightmost antennas is 28 mm. This desktop computer runs Ubuntu 10.04 LTS with 2.6.36 kernel and acts as a Wi-Fi access point using the hostapd software.

Since at the physical RF layer the transmission characteristics are identical for the access point and the mobile unit, for simplicity of our experiments the prototype acted as an access point. It should be noted that in order to locate rogue access points one would need to reconfigure the prototype as a mobile unit.

B. Experimental Setup

Before attempting a field test, with the full impact of noise and multipath effects, the inventors conducted lab experiments using RF signal injection. This allowed us to analyze the performance of our approach in a controlled environment.

RF Channel Simulator: The main idea is to remove the antennas from both the transmitter and the receiver, and replace them by coaxial cables that carry the signal directly from the transmitter to the receiver. An attenuator was added to introduce fading, and also to protect the receiver's circuitry from input overpower. Phase differences were introduced by manipulating the lengths of the coaxial cables.

The transmitted signal was injected into a coaxial cable; after attenuation by 60 dB, this cable was connected to an RF-splitter, and the two output coaxial cables injected the simulated received signal into the two receiving antennas.

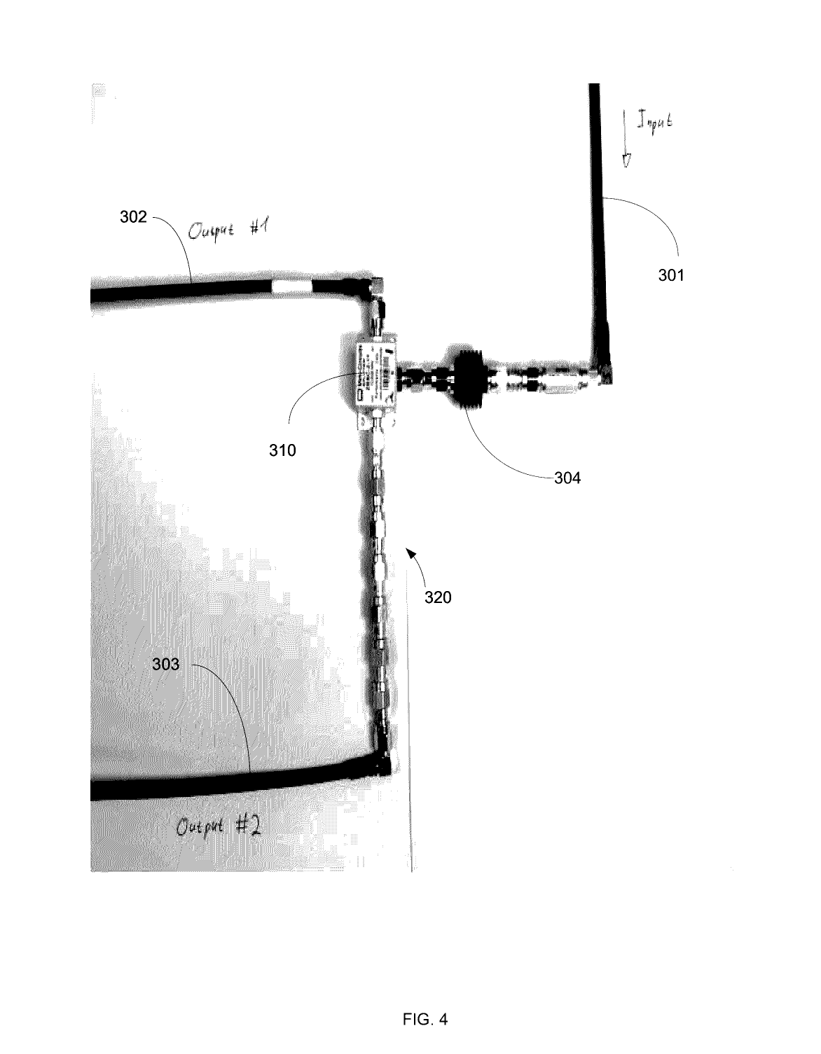

When the two output cables are of the same length, the transmitted signal is received at the two receiver channels with no phase difference (Δφ=0). In order to generate a phase difference between the two channels, the inventors increased the length of one of the cables by means of adding SMA adaptors, delaying the relevant signal, thus accumulating a phase difference between the two channels—see FIG. 4 that illustrates the RF Channel Simulator: Input port 301, attenuator 304, RF splitter 310 and 7 SMA adaptors 320 on one of the two output channels 303 and 302.

This phase difference was measured by our prototype.

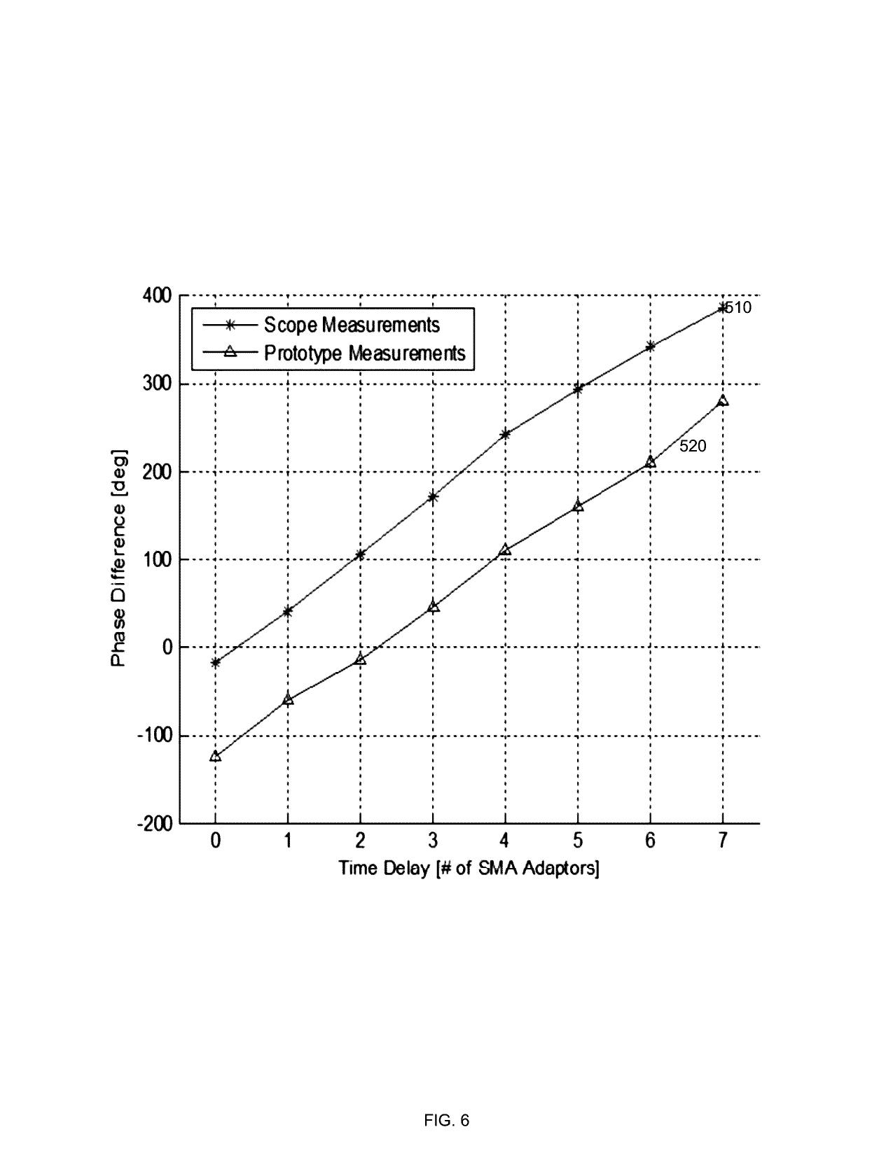

Setup Calibration: For calibrating the experimental setup, the inventors started by injecting a pure sine wave at 1 GHz from a signal generator into the input cable of the RF Channel Simulator (instead of using a Wi-Fi transmitter). The output signals of the two output cables were measured using a scope (LeCroy WavePro 715 Zi, 20 GS/s). When using no SMA adaptors, the inventors measured a delay difference of 20 ps between the two output channels. The inventors then added the SMA adaptors to one of the output channels one at a time, and measured the added delay. The SMA adaptors were found to delay the signal by about 60 ps each. According to Equation (12), the inventors calculated the phase differences of a Wi-Fi signal at a carrier frequency of f_{car}=2:437 GHz, for these measured delays. The results are shown in FIG. 6 as Scope Measurements (blue-stars).

Recording Data: After calibration and preliminary measurements, the inventors conducted the main laboratory experiments.

We injected into the RF Channel Simulator RF signal from a standard off-the-shelf IEEE802.11n NIC (a TP-LINK TLWN722N external USB adapter) that was connected to a laptop. The two output cables carried the RF signals into two antenna ports of the Intel 5300 prototype. This setup provided an RF simulation of a single transmitter, received at the receiver's two antennas, with a controlled phase difference between the receiving antennas (for the rest of this section, by “antenna” we mean an antenna port into which the RF signal is injected by the RF Channel Simulator). The inventors collected CSI data in records of 10-30 seconds each, and analyzed them offline. This experiment was repeated three times.

C. Analyzing the Records

The record files produced by the Intel 5300 drivers of {34} contain, for each received packet, the CSI matrix (of complex numbers) of 2 (receiving antennas)_30 (subcarriers). Looking at the CSI records, the inventors noticed that for each recorded packet, the absolute phase of the received signal appears random. Since there is no phase coherency between consecutive transmitted packets in the IEEE802.11 standard, the randomness of the absolute phase is expected.

When examining each packet's phase difference between the two receiving antennas Δ\hat{φ}=\hat{φ}₂−\hat{φ}₁, the inventors expected to get the physical phase accumulated between the receiving antennas due to the known fixed delay, according to Equation (12).

Surprisingly, although the physical phase difference Δφ of the RF Channel Simulator was kept steady, the inventors observed that the measured phase difference Δ\hat{φ} showed several values in consecutive received packets along the CSI record.

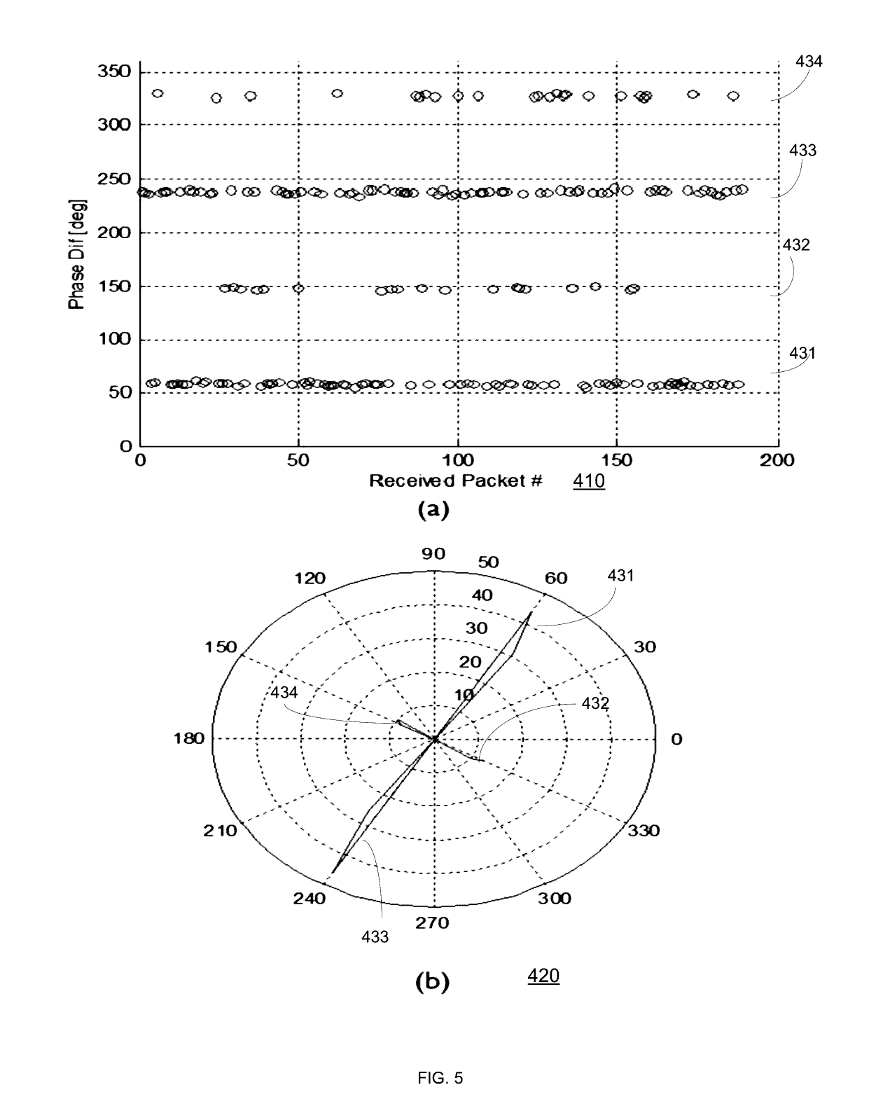

FIG. 5 has two parts that illustrate an analysis of the CSI records: (a) The measured phase difference (graph 410) between the two receiving antennas as a function of received packet #(time) when no SMA adaptors were added. (b) A polar histogram presentation of the same CSI record.

Deeper examination revealed that the measured phase difference Δ\hat{φ} was toggling between four values 431, 432, 433 and 434 that were 90 Degrees apart from each other (60 Degrees, 330 Degrees, 240 Degrees and 150 Degrees), as shown in FIG. 5 part (a) and part (b). the inventors found it convenient to visually analyze the data by using a polar histogram representation of the phase difference, as shown in FIG. 5 part (b): In the polar histogram, the four values constitute a “cross”.

Consulting with the developer of the drivers and firmware {37}, the inventors learned that this four-way ambiguity stems from the implementation of the Intel 5300 card (and is not an inherent ambiguity of the IEEE802.11n standard). In this specific hardware, the PLL locks to the nearest 90 Degrees, independently for each receiving antenna. Thus, unpredictable multiples of 90 Degrees are added to the measured phase \hat{φ}₁ and \hat{φ}₂. As this addition is unpredictable, for each received packet a different multiple of 90 Degrees is added to Δ\hat{φ}. Thus, although the physical phase difference Δφ is fixed, along the record four values of Δ\hat{φ} are generated. Note that in other Wi-Fi cards, different implementations of the PLL may eliminate this ambiguity.

In order to employ the Intel 5300 as an AoA interferometer, it is suggested the following method for resolving the four-way ambiguity. From Equation (6) it is clear that when

$$d < \frac{λ}{8}$$

the physical phase difference obeys

$$\vert Δ φ \vert < \frac{π}{4} .$$

Hence, the valid range of the measured phase difference is

$$\{ - \frac{π}{4} , \frac{π}{4} \} .$$

Since the Intel 5300's four-way ambiguity causes reflections π/2 apart, only a single value can be received in the valid range. the inventors note that for Wi-Fi, λ≈120 mm. Thus, for implementing this method, the distance between the antennas should be

$$d < \frac{λ}{8} \approx 15 mm .$$

For the commercial PCIe adapter the inventors used in the prototype, the three antennas are aligned and the separation between every two adjacent antennas is d=14 mm. the inventors used the two side antennas only, thus the distance between them was

$$d = 28 mm \approx \frac{λ}{4} .$$

In this case, the valid range of the measured phase difference is

$$\{ - \frac{π}{2} ; \frac{π}{2} \} ,$$

thus two reflections of the ambiguity are omitted, while one reflection and the physical value remain in the valid range. To eliminate the remaining ambiguity, the inventors note that the “cross” in FIG. 5(b) is oriented, i.e., it has two long wings and two short wings. This structure was stable and consistent across our experiments, i.e., for a fixed physical phase difference, not only does the measured phase difference “cross” get the same orientations, but also the long/short wings orientation remains constant.

Therefore, the inventors chose to consistently select the long wing, which is the more frequent phase difference, in the valid range

$$\{ - \frac{π}{2} ; \frac{π}{2} \} .$$

By doing so we can solve the ambiguity when the distance between

$$d < \frac{λ}{4} .$$

This four-way ambiguity resolution method requires a onetime 10o calibration, which includes finding the bias of the frequent value from the real value of the phase difference. This calibration requires measuring the most frequent value of the phase difference measurement when the physical value is known, i.e., when the physical AoA is known.

This calibration is discussed in Section V-D.

In the laboratory experiments with the RF Channel Simulator, the delay between the antennas was generated by SMA adaptors (not by a geometric distance between the antennas).

Thus, the inventors could not filter out 2 reflections based on the valid range, and the inventors solved the four-way ambiguity by consistently choosing the same wing from the two long wings of the “cross”. The inventors did implement the full method when analyzing the field experiments' records.

D. Results

As with the scope measurements, the inventors added SMA adaptors one at a time to delay the signal reaching one of the receiving antennas; the inventors measured the phase difference between the two receiving antennas with our prototype. This experiment was repeated five times. The results are presented in FIG. 6 as Prototype Measurements (blacktriangles). FIG. 6 illustrates Phase difference between two received signals as a function of the time delay between the two signals, for scope delay measurements and prototype phase measurements. Scope measurements are represented by curve 510 while prototype measurements were represented by curve 52.

Constant Bias: FIG. 5(b) shows that when no SMA adaptors were added, although the inventors expected to get Δ\hat{φ}=0 Degrees, the most frequent phase difference value was −120 Degrees (240 Degrees). When the inventors switched the cables to the antennas, the result changed to −60 Degrees. Thus the inventors conclude that (a) our prototype's “zero” is on −90 Degrees—this is the calibration of the four-way ambiguity solving method as discussed earlier; and (b) the RF Channel Simulator's “zero” is measured by our prototype as −30 Degrees.

Recall that the RF Channel Simulator's “zero” was measured by a scope as a time difference of 20 ps. Thus, according to Equation (12), at the carrier frequency of Wi-Fi, the inventors expected to measure Δ\hat{φ}=−17.5 Degrees. Hence, our prototype has an additional internal bias of −12.5 Degrees.

As shown in FIG. 6, the results measured by the prototype have a constant bias of −100 Degrees to −110 Degrees from the physical phase differences as calculated according to the delays measured by the scope. This bias is very close to expected (−90 Degrees)+(−12.5 Degrees)—the calibration calculated according to the first measurement (with no SMA adaptors). the inventors used this calibration when analyzing the field experiments' records. Note that this bias is due to the hardware implementation of the Wi-Fi card, and thus calibration should only be done once.

Measuring The Phase Difference: FIG. 6 shows that after compensating for the constant bias (by adding 90 Degrees due to four-way ambiguity and 12.5 Degrees due to the internal bias), our technique provides a precise measurement of the phase difference between the two receiving antennas (and hence, using Equation (3), of the bearing angle θ).

### VI. FIELD EXPERIMENTS

Once validated in the laboratory, the inventors moved on to field experiments.

Experimental Setup

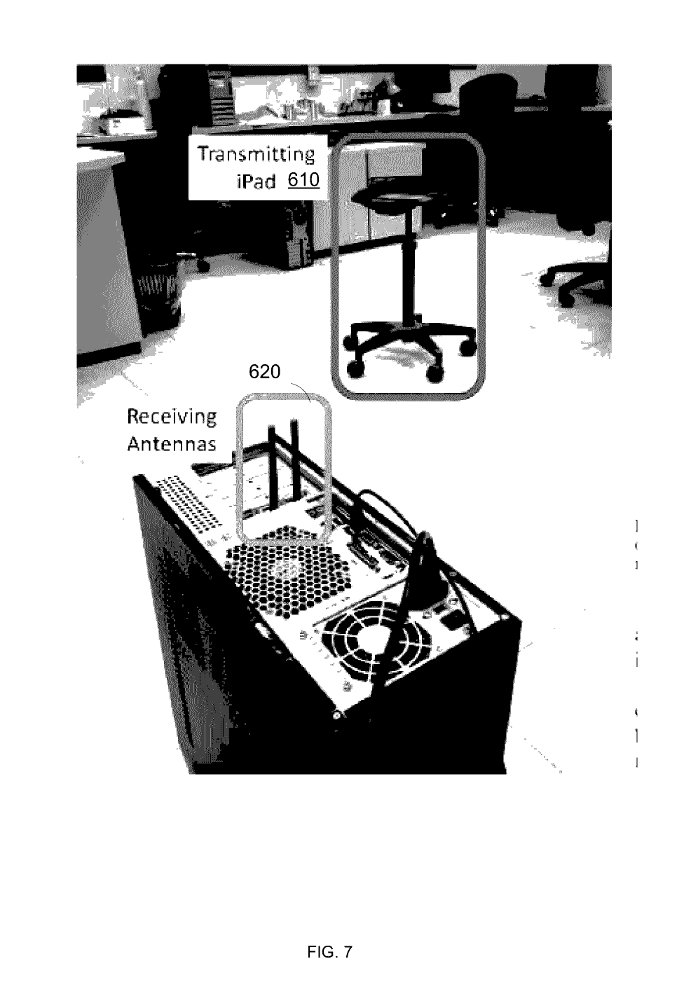

The inventors used the same prototype the inventors had used in the laboratory experiments, except that now two standard Wi-Fi antennas were connected to the receiver's antenna ports. The prototype was placed on the floor of a 5_7 m laboratory room. The antennas were oriented as in standard commercial access point, i.e., the distance between them was according to the design of the PCIe adapter: d=28 mm. The antennas denoted 620) were oriented parallel to each other facing up—see FIG. 7 in which the prototype is in the foreground, and the transmitting iPad (610) is on a lab stool at an angle of approximately θ=45o

The transmitter was located on a lab stool at varying bearing angles θ (projected AoA on the receiving antennas plane), in the range of 1-2 m from the prototype. As transmitters the inventors used several standard Wi-Fi devices: a laptop, an iPad, and an iPhone. In each record provided by the Intel 5300 drivers, which included 80-200 packets, about 10 seconds of communication between the prototype and a single static transmitter were recorded. The experiment was held in a busy environment, having about 10 active Wi-Fi access points in range, and many more Wi-Fi users.

We recorded 59 records, for different bearing angles θ. For each record the inventors performed exactly the same analysis as the inventors had done for the lab records, and measured Δ\hat{φ}: the inventors first added the calibration bias of 12.5 Degrees; then the inventors implemented the four-way ambiguity-resolution method, i.e., the inventors consistently chose the long wing of the “cross” in the valid range {−180 Degrees; 0 Degrees}, and added 90 Degrees to bring it to the range {−90 Degrees; 90 Degrees}.

B. Real-World Noise and Multipath Effects

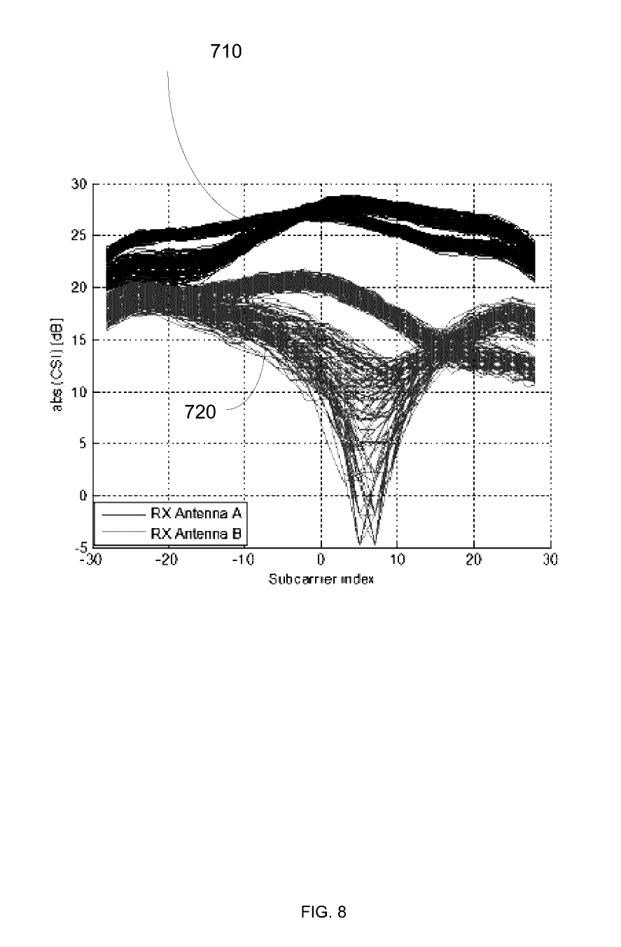

When analyzing the real-world records, the inventors noticed several effects that did not occur in the laboratory experiments: Inconclusive packets: In some of the records, the inventors detected packets with noisy, thus inconclusive, measurements of the phase difference Δ\hat{φ}. When analyzing the channel response of these packets (the absolute value of the CSI data) as recorded by our prototype, the inventors observed that the inconclusive packets were characterized by a frequency-selective channel response, as in the example shown in FIG. 8. FIG. 8 illustrates a channel response of a frequency-selective record as a function of the subcarrier index. Each packet in the record produced 2 curves, one per receiving antenna. Note the sharp drop for subcarriers 0-10 on antenna B. The figure showed a first cluster 710 of less frequency selective channel response while cluster 720 shows frequency selective channel responses.

We believe that this channel response can be caused by the presence of a strong multipath effect, movement of people, or even by interference from nearby transmitters.

As a criterion to identify a frequency-selective channel, the inventors calculated the span of the channel response, i.e., the difference between the maximum and minimum values of the channel response curve. the inventors found that packets for which the span was greater than 12 dB caused inconclusive results. In the analysis the inventors discarded such packets. In some records, after discarding such packets, the inventors had fewer than 30 valid packets, which was our minimum required for obtaining a statistically reliable histogram required for our four-way ambiguity resolution. In such cases, the full record was discarded.

Notably, out of 59 records, 24 records contained at least one inconclusive packet, 12 of which were fully discarded.

Multiple results: In some of the records, the phase difference was toggling between multiple results, i.e., the inventors observe more than one “cross” per each subcarrier. The presence of multiple results was usually observed together with the presence of multiple channel response curves, the inventors argue that this phenomenon is caused by the presence of strong coherent multipath reflections.

In our analysis the inventors chose the most frequent value.

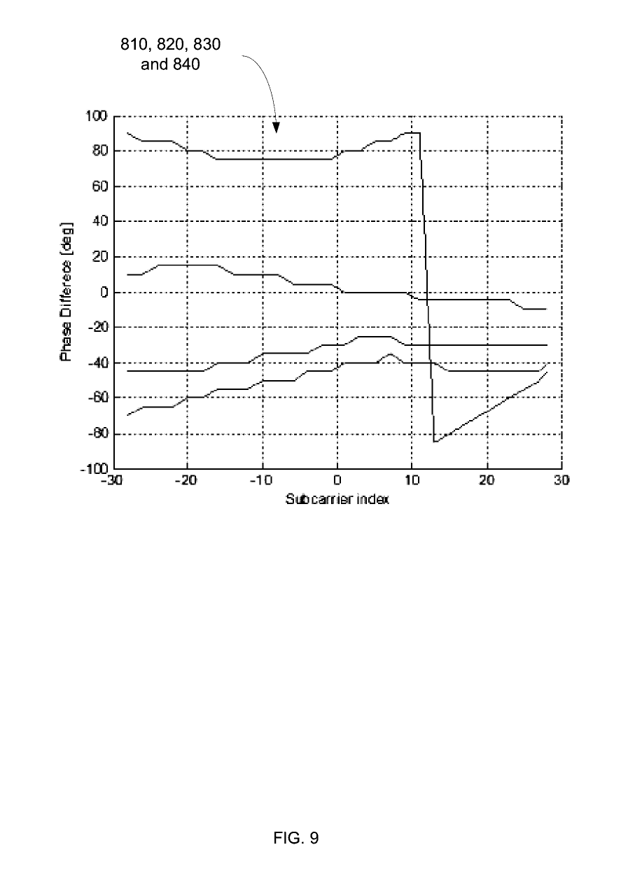

Different results for different subcarriers: In many records, the inventors measured different results for different subcarriers. The values of the measured phase difference Δ\hat{φ}, after resolving the four-way ambiguity, varied as a function of the frequency (subcarrier index). FIG. 9 shows several examples (curves 810, 820, 830 and 840) of typical records. The change in the measured phase difference is much greater than the expected change associated with the frequency separation between the subcarriers. Since the inventors did not observe this behavior in the laboratory, the inventors believe that this too is a result of the multipath, whose impact on different frequencies is quite diverse.

To take this subcarrier dependence into account, the inventors calculated the center-value for each record—the mid-point between the maximum value and minimum value of the phase differences of different subcarriers. the inventors referred to this centervalue as the record's measurement of Δ\hat{φ}.

Some records' results (curve 810) spanned over the ±90 Degrees limit, i.e., split between both ends of the valid range ({−90 Degrees; 90 Degrees}). One example is presented in FIG. 9. In these cases, the inventors calculated the center-value as following: (a) the inventors recognized these records, when the results were not continuously changed along the subcarrier index; (b) the inventors checked which side of the range (i.e., the top {0 Degrees; 90 Degrees}, or the bottom {−90 Degrees; 0 Degrees}) contained a bigger part of the results' span, and brought there all the results (by adding or subtracting 180 Degrees when needed even when it exceeded the valid range); (c) the inventors then calculated the centervalue as before. By doing so, the inventors assured that the center-value was in the valid range {−90 Degrees; 90 Degrees}.

Note that the phase difference measurements' span varied from record to record, and in some records the measurement span between the subcarriers exceeded 45 phase-degrees

$$( \frac{π}{4} radians ) .$$

Even if we assume that the true physical phase difference is the center-value calculated as described above, the error is at least

$$\frac{π}{8} ,$$

which is much larger than

$$\frac{π}{275}$$

which was the maximal error allowed for Phase-Periodic ambiguity resolution using the frequency diversity method.

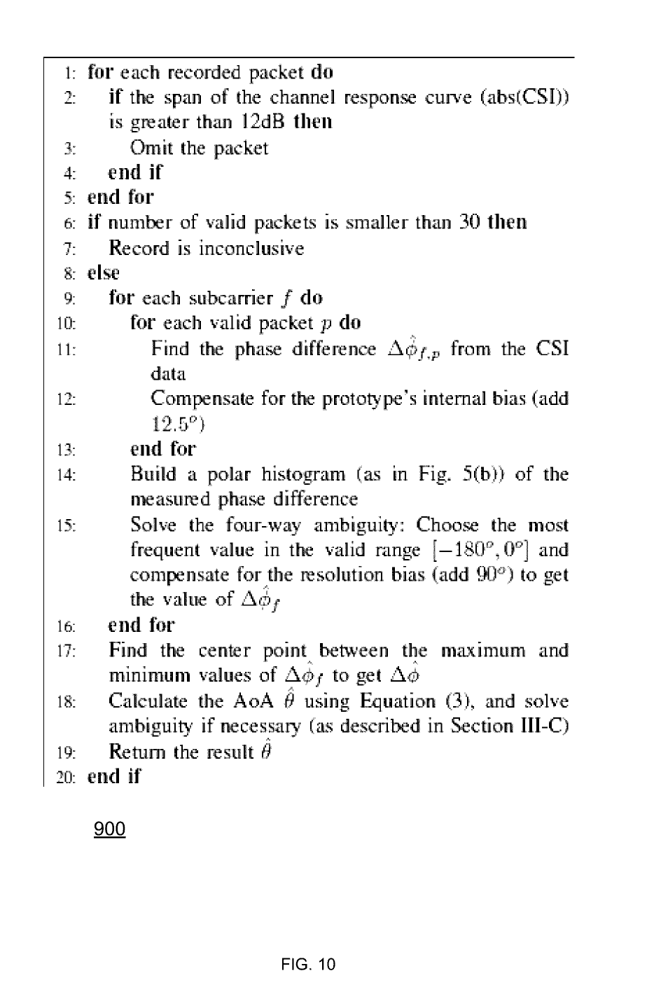

Combining all the ideas reported above, the inventors obtain an AoA estimation algorithm—see FIG. 10 (method 900) that illustrates an AoA estimation algorithm.

C. Results and Discussion

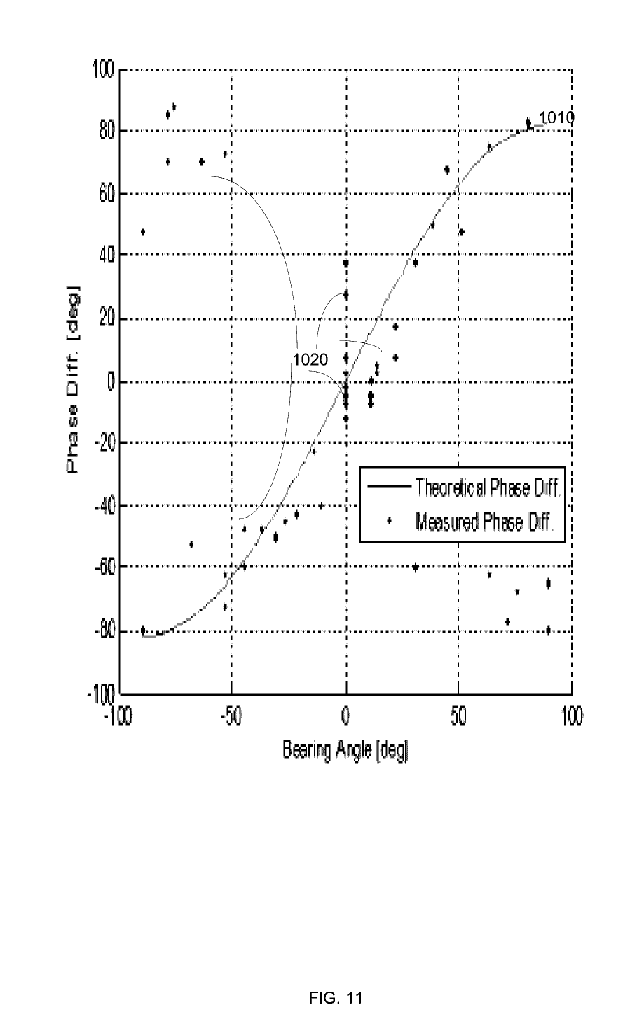

The outcome of applying the AoA algorithm of FIG. 10 to the recorded data is depicted in FIG. 11 that illustrates field experiments results: Theoretical (curve 1010) and measured (dots 1020) phase difference, A4 and A respectively, as a function of the bearing angle.

The field experiments provide a good estimation of the theoretical phase difference according to Equation (3): when the bearing angle |θ|<50°, the median difference between the physical Δφ (red curve) and the measured Δ\hat{φ} (blue dots) is as small as 11.25 phase-degrees, corresponding to an error of 8 degrees in the estimated AoA when θ=0 Degrees, and an error of 15 Degrees when θ=50 Degrees. When |θ|>50 Degrees, the prototype struggled to solve the fourway ambiguity, and the analysis of some records produced an error of 180 Degrees (apparently due to choosing the wrong long wing of the “cross”). This can be solved by another ambiguity-solving method (using closer receiving antennas or another Wi-Fi receiver with other PLL implementation), or by maneuvering the receiver so that the bearing angle would be in the range {−50 Degrees; 50 Degrees}.

### VII. DEALING WITH MULTIPATH EFFECTS

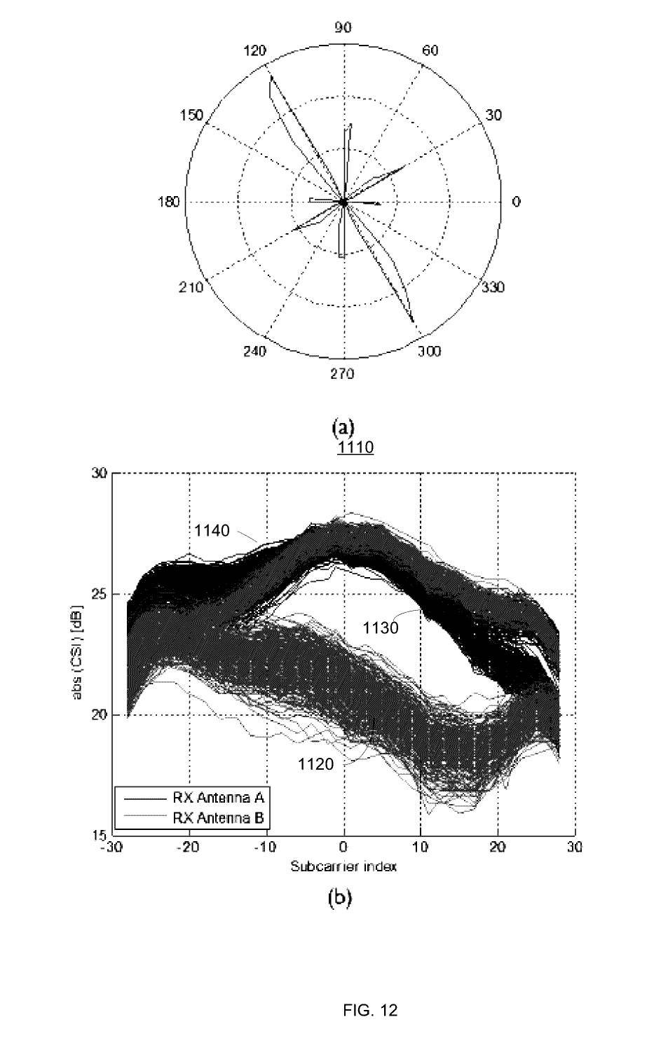

Presence of Multipath Effects As presented earlier, in some of the records the measured phase difference Δ\hat{φ} was toggling between multiple results, i.e., the inventors observe more than one “cross” per each subcarrier. The presence of multiple results was usually observed together with the presence of multiple channel response curves. An example is presented in FIG. 12 that illustrates Multiple coherent wavefronts: (a) Two results (polar histogram 1110) of measured phase difference Δ\hat{φ} (two “crosses”), and (b) Two clusters of channel response curves. Each cluster of channel response curves is associated with each result of measured phase difference. The first cluster 1120 includes frequency selective channel responses and the second cluster includes frequency selective channels 1140 received from first receive antenna and frequency selective channels 1130 received from the second receive antenna.

We argue that this phenomenon is caused by the presence of strong coherent multipath reflections. The appearance of the multiple results can be explained by the existence of more than one strong wavefront—e.g., a strong multipath reflection in addition to the LoS signal. In such case, some packets were received when the receiver was measuring one wavefront (e.g., the LoS), which provided one value of Δ\hat{φ} and one channel response curve, while other packets were received when the receiver was measuring the other wavefront (e.g., the multipath reflection), which provided another value of Δ\hat{φ} and another channel response curve.

Since in most of the records the inventors got exactly two results, which provided relatively close values of Δ\hat{φ} (thus of θ, the horizontal AoA), and according to the physical setup of the experiments as shown in FIG. 7, the inventors believe that the results are a LoS and a strong ground-reflection.

Dealing with Multipath Effects

One way to mitigate multipath is by means of classifying the different packets according to their channel response curves, and treating each cluster independently. There are many clustering algorithms that can be used for this purpose. the inventors implemented the clustering phase manually.

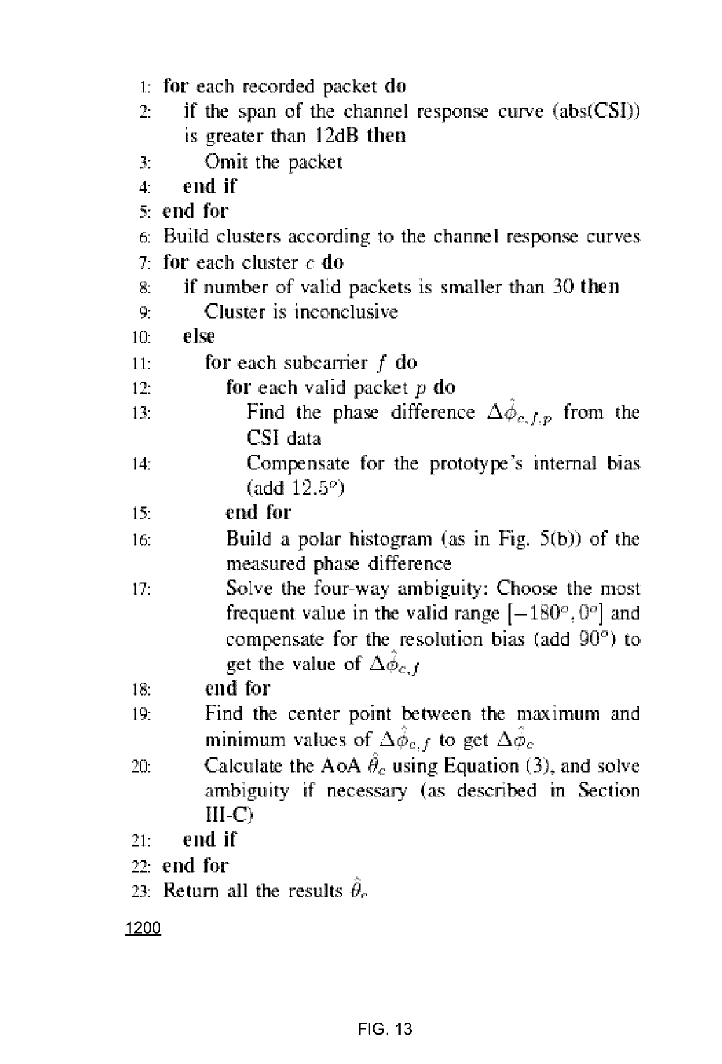

It is suggested an updated AoA estimation algorithm which deals with coherent multipath reflections—see FIG. 13 (method 1200) that illustrates that provides AoA estimation algorithm (updated to deal with coherent multipath reflections. The outcome of the application of the updated AoA algorithm of FIG. 13 to the recorded data, showed that, as expected, each cluster of channel response curves really was associated with another result (“cross”) of the measured phase difference Δ\hat{φ} (thus another estimation of the AoA θ).

Practically, the prototype provides several results of AoA estimation for each static record. Each of these results refers to another coherent wavefront of the received signal, i.e., to another physical AoA of the signal. This ambiguity can be solved on the application level, by tracking each of the AoA results change along time, specifically while generating a mechanical movement of the receiver. When the physical geometry of the scene is known, the application or the user can decide which result points toward a potential reflector and which points toward a potential location of the transmitter.

### VIII. CONCLUSIONS

Using off-the-shelf hardware, the inventors introduced a practical Direction Finding method for identifying the AoA of a Wi-Fi transmitter. This method can be employed for locating rogue Wi-Fi access points by means of a commercial receiver.

A key ingredient in the proposed approach is the usage of CSI data, whose extraction is mandatory in modern OFDM receivers, for filtering out noisy data, and for the implementation of interferometry-based Direction Finding. the inventors investigated the proposed approach theoretically, via numerical simulation, and practically, by utilizing a prototype board based on a commercial Intel 5300 Wi-Fi NIC.

Our prototype provided an AoA estimation in the range {−50 Degrees; 50 Degrees}, with a median error smaller than 15 Degrees. The angle range-limitation was a consequence of ambiguity caused by the specific PLL implementation of the Intel 5300. The full {−90 Degrees; 90 Degrees} range of angles can be approached by improving the ambiguity resolution method, or otherwise by using different commercially available hardware.

As we take advantage of inherent characteristics of OFDM and MIMO, the proposed method is readily applicable for other modern wireless standards such as LTE.

According to an embodiment of the invention the location of the OFDM transmitter may be calculated while taking into account the source of the inaccuracy of the phase difference measurements—both the internal bias of the prototype as well as the change of the results as a function of the frequency (subcarrier index).

According to an embodiment of the invention the location of the OFDM transmitter may include implementing advanced ambiguity solving methods.

According to an embodiment of the invention a usage of CSI information of higher resolution may allow an AOA estimation based upon a single packet.

Since most access points use MIMO with at least 2 antennas, when using 2 receiving antennas the Intel 5300 would produce 2_2 CSI data. Thus we could calculate two separate AoAs—one per transmitting antenna—and use this information for additional ambiguity resolution.

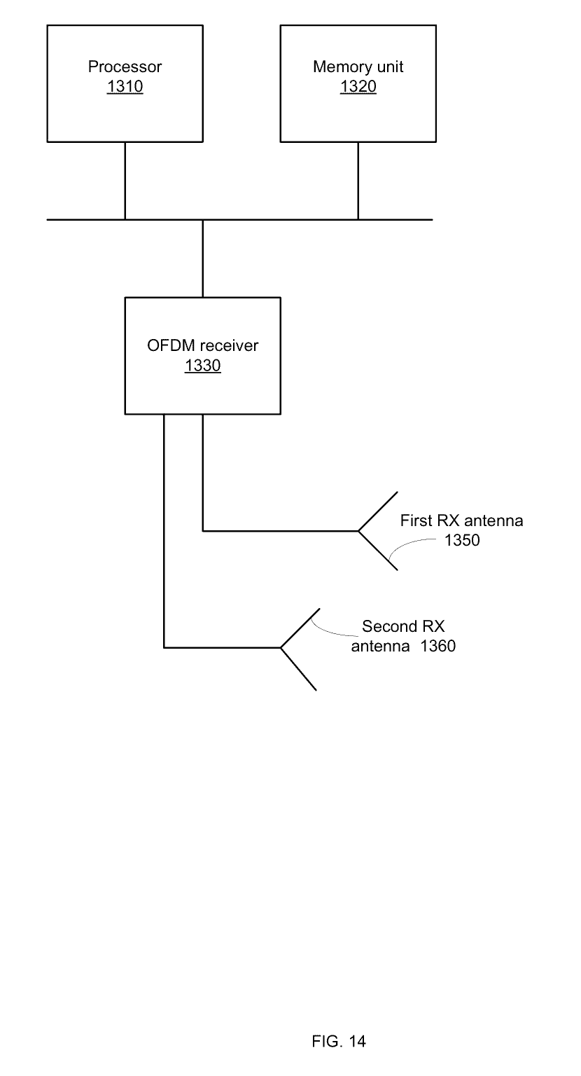

FIG. 14 illustrates an OFDM receiver 1330 that has two receive antennas 1350 and 1360. The OFDM receiver 1330 sends CSI to memory unit 1320 and to processor 1310.

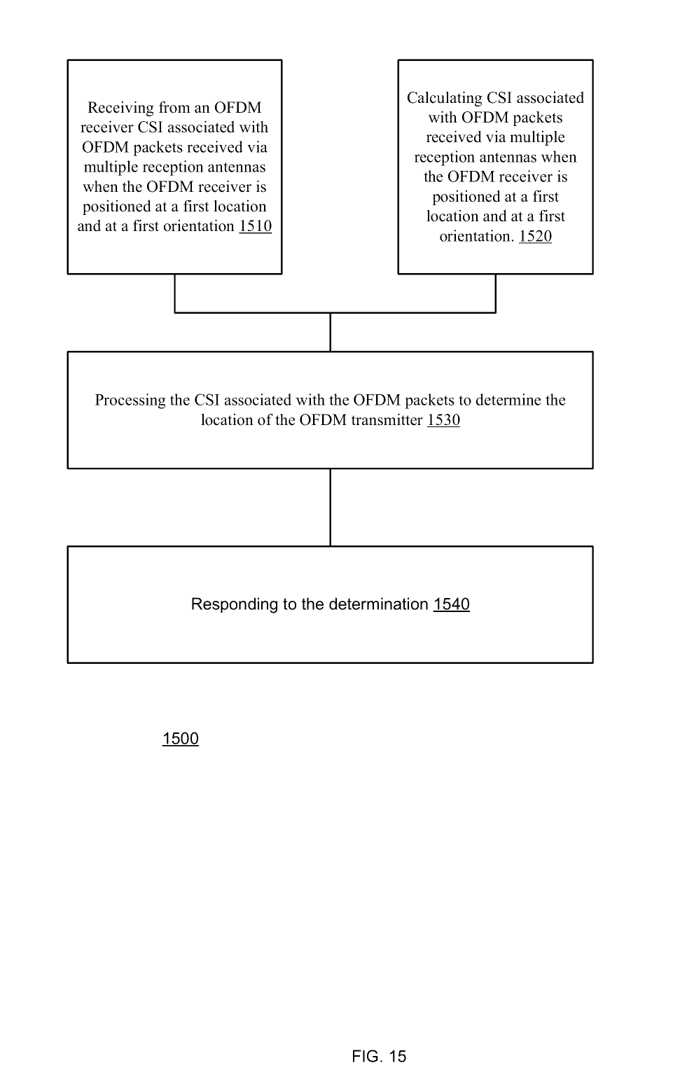

FIG. 15 illustrates method 1500 according to an embodiment of the invention.

Method 1500 may start by stage 1510 of by stage 1520.

Stage 1510 may include receiving from an OFDM receiver channel state information (CSI) associated with OFDM packets received via multiple reception antennas when the OFDM receiver is positioned at a first location and at a first orientation.

Stage 1520 may include calculating channel state information (CSI) associated with OFDM packets received via multiple reception antennas when the OFDM receiver is positioned at a first location and at a first orientation.

In relation to stages 1510 and 1520—all the CSI may relate to OFDM packets that were received when the OFDM receiver was static.

It is noted that the CSI may relate to OFDM packets received when the receiver was moved from one location to the other but the method can provide adequate results even when the CSI related to OFDM packets received when the OFDM receiver was static.

It is further noted that the OFDM signals may be received from different orientations of the multiple reception antennas but the method can provide adequate results even when the CSI related to OFDM packets received when the OFDM receiver was static and not rotated.

Stage 1510 and 1520 may be followed by 1530 of processing the CSI associated with the OFDM packets to determine the location of the OFDM transmitter.

The processing of stage 1530 may fulfill at least one of the following:

The determining of the location of the OFDM transmitter may be responsive to spatial relationships (distance and relative location) between the multiple reception antennas.

Estimating channel responses related to different subcarriers (see, for example FIGS. 8 and 12 and line 11 of FIG. 13).

Clustering subcarriers to clusters according to their channel response and determining the angle of arrival per cluster (see, for example, lines 9 and 20 of FIG. 13).

Ignoring CSI related to subcarriers of the OFDM packets that propagate through channels that exhibit a span of channel responses that exceed a predefined threshold (see, for example, line 2 of FIG. 10).

Compensating for an angular bias of the OFDM receiver (see, for example, line 14 of FIG. 13).

Resolving at least one ambiguity out of a phase periodic ambiguity and a symmetric ambiguity (see, for example FIGS. 1 and 3 and ambiguity resolution section of the application).

Resolving of the phase periodic ambiguity by selecting between multiple estimated phase differences (see boxes 201 of FIG. 3), wherein each estimated phase difference is indicative of differences in timing of receptions, by the multiple reception antennas, of same OFDM packets. The multiple estimated phase differences differ from each other multiple integers of one hundred and eighty degrees.

Resolving of the symmetric ambiguity comprises selecting between a first estimated value of an angle of arrival of an OFDM packet and between a second estimated value of the angle of arrival of the OFDM packet, wherein a sum of the first estimated value and the second estimated value equals one hundred and eighty degrees (see circle 202 and triangle 201 of FIG. 3).

Receiving from the OFDM receiver or calculating CSI associated with another set of OFDM packets received via multiple reception antennas when the multiple reception antennas were at the first position but are oriented at a second orientation (see ambiguity resolution by mechanical intervention).

Comparing between intensities of same OFDM packets that were received by different reception antennas.

Compensating for the inconsistency phase information of one OFDM packet in case when the phase information of a CSI packet is calculated by the OFDM receiver regardless of phase information of another OFDM packet (see the four way ambiguity, line 17 of FIG. 13).

Compensating for inconsistent phase information (see the four way ambiguity) wherein the compensation is responsive to a distribution of phase differences (see for example phase histograms of FIGS. 5 and 12), wherein each phase difference is indicative of an estimated phase difference between receptions of a same OFDM packet by different reception antennas, finding a most popular phase difference value within a predefined angular range; and adding a phase offset to the most popular phase difference to provide an estimate of the phase difference.

Calculating the location of the OFDM transmitter in response to phase differences calculated for multiple antennas and for one or multiple OFDM packets per one or many subcarriers.

Stage 1530 may be followed by stage 1540 of responding to the determination. Stage 1540 may include providing (displaying, generating an audio message, sending an alert over a network) one or more estimate of the location of the OFDM transmitter.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for estimating a location of an Orthogonal Frequency Division Multiplexing (OFDM) transmitter, the method comprising:
receiving from an OFDM receiver or calculating channel state information (CSI) associated with OFDM packets received via multiple reception antennas when the OFDM receiver is positioned at a first location and at a first orientation; and
processing the CSI associated with the OFDM packets to determine the location of the OFDM transmitter;
wherein the determining of the location of the OFDM transmitter is further responsive to spatial relationships between the multiple reception antennas.

2. The method according to claim 1 wherein the estimating of the location of the OFDM transmitter is executed without moving the multiple reception antennas.

3. The method according to claim 1 wherein the processing comprises distinguishing between CSI of OFDM packets related to different subcarriers.

4. The method according to claim 1 wherein the processing comprises estimating channel responses related to different subcarriers.

5. The method according to claim 1 wherein the processing comprises ignoring CSI related to subcarriers of the OFDM packets that propagate through channels that exhibit a span of channel responses that exceed a predefined threshold.

6. The method according to claim 1 wherein the processing comprises compensating for an angular bias of the OFDM receiver.

7. The method according to claim 1 wherein the processing comprises resolving at least one ambiguity out of a phase periodic ambiguity and a symmetric ambiguity;
wherein the resolving of the phase periodic ambiguity comprises selecting between multiple estimated phase differences, wherein each estimated phase difference is indicative of a differences in timing of receptions, by the multiple reception antennas, of same OFDM packets;
wherein the multiple estimated phase differences differ from each other multiple integers of one hundred and eighty degrees; and
wherein the resolving of the symmetric ambiguity comprises selecting between a first estimated value of an angle of arrival of an OFDM packet and between a second estimated value of the angle of arrival of the OFDM packet, wherein a sum of the first estimated value and the second estimated value equals one hundred and eighty degrees.

8. The method according to claim 7 wherein the resolving of the at least one ambiguity comprises:
receiving from the OFDM receiver or calculating CSI associated with another set of OFDM packets received via multiple reception antennas when the multiple reception antennas were at the first position but are oriented at a second orientation; and
processing the CSI associated with the additional set of OFDM packets.

9. The method according to claim 1 wherein the processing comprises comparing between intensities of same OFDM packets that were received by different reception antennas.

10. The method according to claim 1 wherein the CSI comprises phase information that is inconsistent between OFDM packets, wherein the processing comprises compensating for the inconsistency.

11. The method according to claim 10 wherein the phase information of one OFDM packet is calculated regardless of phase information of another OFDM packet.

12. The method according to claim 10 wherein the compensating is responsive to a distribution of phase differences, wherein each phase difference is indicative of an estimated phase difference between receptions of a same OFDM packet by different reception antennas.

13. The method according to claim 10 wherein the compensating comprises finding a most popular phase difference value within a predefined angular range and adding a phase offset to the most popular phase difference to provide an estimate of the phase difference.

14. The method according to claim 1 comprising calculating the location of the OFDM transmitter in response to phase differences calculated for multiple antennas and for one or multiple OFDM packets per one or many subcarriers.

15. The method according to claim 1 wherein the processing comprises clustering subcarriers of the OFDM packets to clusters according to channel responses associated with the subcarriers and providing an estimate of a location of the transmitter per cluster.

16. The method according to claim 1 wherein the estimating of the location of the OFDM transmitter is executed while moving the multiple reception antennas.

17. The method according to claim 1 further comprising providing an indication about the estimated location of OFDM transmitter.

18. The method according to claim 17 wherein the indication is a visual indication.

19. The method according to claim 18 wherein the visual indication is an arrow that points towards the estimated location of the OFDM transmitter.

20. The method according to claim 17 wherein the indication is an audio indication.

21. A computerized device comprising a memory unit and a processor, wherein the memory unit is configured to store channel state information (CSI) associated with Orthogonal Frequency Division Multiplexing OFDM packets received via multiple reception antennas; wherein the processor is configured to process the CSI associated with the OFDM packets to determine the location of the OFDM transmitter; wherein the determining of the location of the OFDM transmitter is further responsive to spatial relationships between the multiple reception antennas.

22. The computerized device according to claim 21 wherein the multiple reception antennas belong to the device.

23. A non-transitory computer readable medium that stores instructions that once executed by a computer cause the computer to perform the steps of: receiving from a Orthogonal Frequency Division Multiplexing (OFDM) receiver or calculating channel state information (CSI) associated with OFDM packets received via multiple reception antennas when the OFDM receiver is positioned at a first location and at a first orientation; and processing the CSI associated with the OFDM packets to determine the location of the OFDM transmitter;
wherein the determining of the location of the OFDM transmitter is further responsive to spatial relationships between the multiple reception antennas.
